(19) United States
(12) Patent Application Publication
(10) Pub. No.: US 2012/0054362 A1
(43) Pub. Date: Mar. 1, 2012

(54) MECHANISM FOR AUTOTUNING MASS DATA TRANSFER FROM A SENDER TO A RECEIVER OVER PARALLEL CONNECTIONS

(75) Inventors: Yeongtau Louis Tsao, Irvine, CA (US); Craig M. Mazzagatte, Aliso Viejo, CA (US); Prateek Jain, Tustin, CA (US)

(73) Assignee: CANON KABUSHIKI KAISHA, Tokyo (JP)

(21) Appl. No.: 12/873,305

(22) Filed: Aug. 31, 2010

(51) Int. Cl. G06F 15/16

(52) U.S. Cl. 709/232

(57) ABSTRACT

The present disclosure is directed to performing mass transfer of data over plural connections established between a sender and a recipient connected to the sender via a network. Data is sent from the sender to the recipient by divided sending of the data over the plural connections. The optimal number of connections between the sender and the recipient is autotuned by closing an existing connection when a detection is made that a bottleneck to mass transfer of data exists in an I/O storage system of the recipient, and by opening a new connection when the I/O storage system of the recipient is writing data faster than data is received from the network. The number of connections is further autotuned by opening a new connection when an I/O storage system of the sender is reading data faster than data is being sent out over the network, and by closing an existing connection when the I/O storage system of the sender is reading data slower than data is being sent out over the network and more than one sender is sending data to the recipient.

### BACKGROUND

1. Field

The present disclosure generally relates to data transfer from a sender to a receiver over a network, and more specifically relates to mass data transfer from a sender to a receiver over a network using a parallel data protocol.

2. Description of the Related Art

When transferring data in a sender-receiver system, a parallel data protocol can be used for mass data transfer in the sender-receiver system where the sender and receiver communicate over one or more networks. Examples of sender-receiver systems include client-server systems and peer-to-peer systems. In such a sender-receiver system, it previously has been considered to open plural, parallel connections between the sender and the receiver, such as plural TCP connections. The purpose of opening plural connections is to aggregate an available bandwidth of a network. More precisely, a single connection between the sender and the receiver might not use all of the available bandwidth in a given network. By opening plural, parallel connections, it is possible to achieve maximum utilization of the bandwidth in any one particular network.

### SUMMARY

One problem with aggregation of bandwidth is that the amount of bandwidth made available might be so large that it outperforms the ability of the recipient to store data or the ability of the sender to retrieve data for transmission. In such data transfers, a bottleneck of data transfer from the sender to the receiver might not be caused by a lack of available network bandwidth. In particular, in a situation that there is a surplus of available bandwidth, the bottleneck of data transfer is actually the physical I/O involved in reading and writing data to a disk.

If the bandwidth of the I/O storage system is the bottleneck, then systems that aggregate bandwidth through use of multiple, parallel connections will monopolize more available network sockets than they are able to use. Such an arrangement is unfair to other sender-receiver systems that operate over the same communication networks.

In the present disclosure, the foregoing problems are addressed by autotuning a number of connections between a sender and a recipient connected to the sender via a network, based on a performance of an I/O storage system. The number of connections is autotuned by opening and/or closing connections so as to establish an optimal number of connections between two systems. Autotuning can specifically occur by closing an existing connection when a detection is made by the recipient that a bottleneck to mass transfer of data exists in an I/O storage system of the recipient, and by opening a new connection when the I/O storage system of the recipient is writing data faster than data is received from the network. Moreover, the number of connections between the sender and the recipient is autotuned by opening a new connection when an I/O storage system of the sender is reading data faster than data is being sent out over the network, and by closing an existing connection when the I/O storage system of the sender is reading data slower than data is being sent out over the network and more than one sender is sending data to the recipient.

Thus, in an example embodiment described herein, plural connections are established between the sender and the recipient via the network. The plural connections may be, for example, plural TCP connections. Data is then sent from the sender to the recipient by divided sending of the data over the plural connections so as to aggregate a utilization of a bandwidth of the network. The optimal number of connections between the sender and the recipient is autotuned by closing an existing connection when a detection is made by the recipient that a bottleneck to mass transfer of data exists in an I/O storage system of the recipient. In this regard, the closing of the existing connection is a closing of a secondary connection, not a primary connection. The number of connections is further autotuned by opening a new connection when the I/O storage system of the recipient is writing data faster than data is received from the network. In addition, the number of connections between the sender and the recipient is autotuned by opening a new connection when an I/O storage system of the sender is reading data faster than data is being sent out over the network. The number of connections is further autotuned by closing an existing connection when the I/O storage system of the sender is reading data slower than data is being sent out over the network and more than one sender is sending data to the recipient.

By virtue of the foregoing arrangement, it is ordinarily possible to provide a self calibration in which a sender and a receiver dynamically increase and decrease the number of connections so as to improve performance for large data transfers by providing an ideal throughput. In addition, fairness is maintained across a large number of sender-receiver arrangements. For example, if the current bottleneck is a system I/O of the recipient, such that the current number of parallel connections has aggregated a surplus of network bandwidth, then some of the connections can be closed, so as to release bandwidth for use by other sender-receiver systems.

In an example embodiment also described herein, the I/O storage system of the recipient includes a disk. In this example embodiment, when autotuning the number of connections, an affirmative detection is made of a bottleneck to mass transfer of data in the I/O storage system of the recipient when a seek operation of the disk is performed on the I/O storage system of the recipient. More specifically, data may not arrive in order at the recipient because plural connections are being used. If the recipient times out waiting for a next consecutive data chunk, the I/O storage system of the recipient may do a disk write for out of order data, which might require additional seek operations. This typically means that data is being transferred from the sender to the recipient faster than the I/0 storage system of the recipient is writing data to the disk. Thus, a bottleneck might exist in the I/O storage system of the recipient.

In an additional example embodiment described herein, the I/O storage system of the recipient includes a disk. In this additional example embodiment, when autotuning the number of connections, an affirmative detection is made of a bottleneck to mass transfer of data in the I/O storage system of the recipient when the I/O storage system of the recipient is writing data to the disk slower than a previous I/O write rate. The previous I/O write rate can be based on a previously measured I/O write rate for more than one writing operation, or can be based on a previously measured I/O write rate for a time period of write operation, or can be based on a weighted average of previously measured I/O write rates of writing operations. For example, if a previous I/O write rate of the I/O storage system of the recipient is 10 Mb/s, and the I/O storage system of the recipient is currently writing data at 5 Mb/s, then a bottleneck might exist in the I/O storage system of the recipient. The slowing I/O storage system write rate of the recipient may occur when, for example, the I/O storage system is processing other non-MDT applications.

In another example embodiment described herein, autotuning of the number of connections further comprises closing by the sender an existing connection between the sender and the recipient in a case that the sender detects that a bottleneck to mass transfer of data exists in the network. As a result, further congestion of the network can be reduced. In this example embodiment, an affirmative detection is made of a bottleneck to mass transfer of data in the network when a current round-trip time (RTT) is longer than a previous RTT. The current RTT and the previous RTT can be based on RTTs for more than one message package, or can be based on a weighted average of RTTs. If the current RTT is substantially longer than the previous RTT, then the network may be busy and have more traffic from other sender-recipient systems. By closing an existing connection when the network is busy, any further congestion caused by sending more data over the busy network may be reduced.

In an additional example embodiment described herein, autotuning of the number of connections further comprises closing an existing connection between the sender and the recipient in a case that the sender detects that a bottleneck to mass transfer of data exists in the I/O storage system of the sender. An affirmative detection is made of a bottleneck to mass transfer of data in the I/O storage system of the sender when a buffer at the sender is substantially empty.

In yet another example embodiment described herein, in a case that the sender detects that a buffer at the sender is substantially full, the sender sends a request to the recipient to open a new connection, or utilizes a connection that has already been created but is not currently being used to send data. Opening a new connection when a buffer at the sender is substantially full has an advantageous effect of providing a smooth overall data transfer because delays or gaps in sending data from the sender can be reduced. In some situations, a buffer size at the sender and the recipient can be adjusted in accordance with a detection of a bottleneck in the network, or in accordance with a detection of a bottleneck in the I/O storage system of the recipient. Specifically in this example embodiment, the size of the buffer at the sender can be increased to possibly prevent the buffer from overflowing with data.

According to another example embodiment described herein, plural senders exist that are each sending a respective one of plural mass data transfers to the recipient. In this example embodiment, when establishing plural connections between the sender and the recipient via the network, the recipient sets a maximum number of connections that can be established between the sender and the recipient based on the number of requested connections from the other senders. For example, if the recipient has a maximum of 20 connections that all of the senders can share, and other senders are currently utilizing 15 of the 20 connections, then the recipient may set a maximum of 5 connections on which the sender may use to transfer data based on the 15 connections being used by the other senders. Also in this example embodiment, the recipient sets a time period for which the maximum number of connections can be established based on the number of requested connections from the other senders. In addition, the recipient sets a starting time for establishing each connection of the maximum number of connections that can be established based on the number of requested connections from the other senders. For example, if a maximum of 3 connections is set by the recipient, a first secondary connection may be established one minute after a primary connection is established and the first secondary connection may last for 4 minutes, and a second secondary connection may be established two minutes after the primary connection is established and the second secondary connection may last for 2 minutes.

In an additional example embodiment described herein, a job queue is maintained by a schedule manager, which governs the number of current connections existing between all of the plural senders, as compared to an incoming number of requested connections. In addition, the schedule manager assigns a priority to each of the plural senders. In this regard, the schedule manager assigns a larger number of connections to a higher priority sender as compared to a lower number of connections to a lower priority sender.

According to another example embodiment described herein, the sender sends a request to the recipient to open one or more connections when an I/O storage system of the sender is reading data faster than data is being sent out over the network. When autotuning the number of connections, the recipient opens the requested one or more connections if the one or more connections are determined available by the schedule manager.

According to an additional example embodiment described herein, the sender sends a request to the recipient to open one or more connections when a current round-trip time (RTT) has substantially decreased from a previous RTT. The current RTT and the previous RTT can be based on RTTs for more than one message package, or can be based on a weighted average of RTTs. When autotuning the number of connections, the recipient opens the requested one or more connections if one or more connections are determined available by the schedule manager.

This brief summary has been provided so that the nature of the disclosure may be understood quickly. A more complete understanding can be obtained by reference to the following detailed description and to the attached drawings.

### BRIEF DESCRIPTION OF DRAWINGS

FIG. 1 is a representative view of multiple senders and a recipient, connected via a network, on which an architecture of an example embodiment may be implemented.

FIG. 2 is a detailed block diagram for explaining the internal architecture of a sender of FIG. 1.

FIG. 3 is a detailed block diagram for explaining the internal architecture of the recipient of FIG. 1.

FIG. 4A is a view of a sender and a recipient for explaining an establishment of a primary connection between the sender and the recipient, according to an example embodiment.

FIG. 4B is a view of a sender and a recipient for explaining an establishment of a secondary connection between the sender and the recipient, according to an example embodiment.

FIG. 5 is a sequence diagram for providing an explanation of a recipient notifying a sender to increase or decrease a number of connections in a session according to an example embodiment.

FIG. 6 is another view of a sender and a recipient for providing a general explanation of sending data from the sender to the recipient according to an example embodiment.

FIG. 7 is a class diagram for a transport sender according to an example embodiment.

FIG. 8 is a class diagram for a transport receiver according to an example embodiment.

FIG. 9 is a class diagram for a server dispatcher according to an example embodiment.

FIG. 10 is a class diagram for a data source according to an example embodiment.

FIG. 11 is a class diagram for a client interaction according to an example embodiment.

FIG. 12 is a class diagram for a server interaction according to an example embodiment.

FIGS. 13A and 13B are a sequence diagram at a client side in “put” scenario.

FIGS. 14A and 14B are a sequence diagram at a provider side in a “put” scenario.

FIG. 15 is a sequence diagram at a client side in a “get” scenario.

FIG. 16 is a sequence diagram at a provider side in a “get” scenario.

FIG. 17 is a sequence diagram at a client side for cancelling a “get” operation.

FIG. 18 is a sequence diagram at a provider side for cancelling a “get” operation.

FIG. 19 is a sequence diagram at a client side for cancelling a “put” operation.

FIG. 20 is a sequence diagram at a provider side for cancelling a “put” operation.

FIG. 21 is a representative view of a writing operation in an I/O storage system of the recipient of FIG. 1.

FIG. 22 is a representative view of the DataWriteQueue 2101 as shown in FIG. 21.

FIG. 23 is another representative view of a writing operation in an I/O storage system of the recipient of FIG. 1.

FIG. 24A is a sequence diagram for detecting a bottleneck in data transfer in an I/O storage system of the sender 101 in FIG. 1.

FIG. 24B is a representative view of a reading operation in an I/O storage system of the sender 101 in FIG. 1.

FIG. 25 is a class diagram for a server according to an example embodiment.

FIG. 26 is a class diagram for a client according to an example embodiment.

FIG. 27 is a class diagram for a data serializer according to an example embodiment.

FIG. 28 is a class diagram for a data deserializer according to an example embodiment.

FIG. 29 is a sequence diagram for establishing a session at a client.

FIG. 30 is a flow chart for providing a description for establishing a start session at the sender according to an example embodiment.

FIG. 31 is a flow chart for providing a description for establishing a join session at the sender according to an example embodiment.

FIG. 32 is a sequence diagram for establishing a session at a server.

FIG. 33 is a flow chart for providing a description for establishing a session at the recipient according to an example embodiment.

FIG. 34 is a sequence diagram for data exchange at a client.

FIGS. 35 and 36 are a flow chart for providing a description for data exchange at the sender.

FIG. 37 is a sequence diagram for data exchange at a server.

FIGS. 38 and 39 are a flow chart for providing a description for data exchange at the recipient.

FIG. 40 is a flow chart for providing a detailed explanation of another example embodiment.

### DETAILED DESCRIPTION

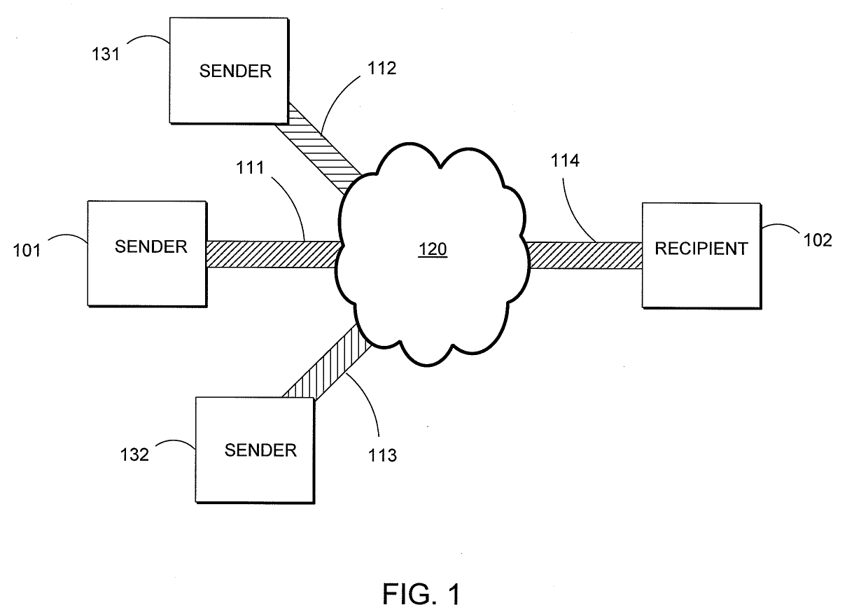

FIG. 1 is a representative view of multiple senders and a recipient, connected via a network, on which an architecture of an example embodiment may be implemented. As shown in FIG. 1, senders 101, 131 and 132 are connected to recipient 102 through network 120. More specifically, sender 101 is connected to network 120 through network interface 111, sender 131 is connected to network 120 through network interface 112, sender 132 is connected to network 120 through network interface 113, and recipient 102 is connected to network 120 through network interface 114. In FIG. 1, senders 101, 131 and 132 are shown to be connected via one network; however, in other example embodiments, senders 101, 131 and 132 and recipient 102 can be connected via more than one network. In addition, there may be more or less than three senders and more than one recipient connected to network 120 or connected to multiple networks.

Network 120 is an intranet, but in other example embodiments, network 120 can be the Internet, or any other suitable type of network for transferring data.

Senders 101, 131 and 132 are devices that are capable of sending a mass transfer of data over a network. However, senders 101, 131 and 132 are not limited to sending data, and can also be devices capable of receiving transferred data. Senders 101, 131 and 132 can be, for example, computers, or any other device that is capable of sending a mass transfer of data over a network. In addition, senders 101, 131 and 132 may be a client device in a client-server system, or may be a peer device in a peer-to-peer system.

Recipient 102 is a device that is capable of receiving and sending a mass transfer of data over a network. Recipient 102 can be, for example, a computer, or any other device that is capable of receiving and sending a mass transfer of data over a network. In addition, recipient 102 may be a server device in a client-server system, or may be a peer device in a peer-to-peer system.

Network interfaces 111 to 114 can be wired or wireless physical interfaces. Each of network interfaces 111 to 114 includes one or more ports so as to establish one or more socket connections with the network 120.

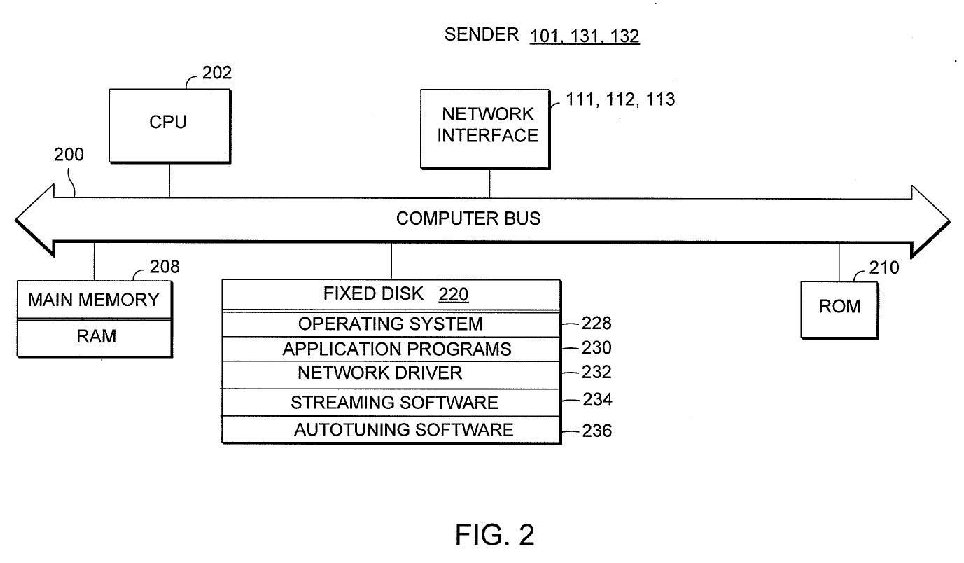

FIG. 2 is a detailed block diagram for explaining the internal architecture of each of senders 101, 131 and 132 of FIG. 1. As shown in FIG. 2, each of senders 101, 131 and 132 may include central processing unit (CPU) 202 which interfaces with computer bus 200. Also interfacing with computer bus 200 are hard (or fixed) disk 220, network interface 111, 112 or 113, random access memory (RAM) 208 for use as a main run-time transient memory, and read only memory (ROM) 210.

RAM 208 interfaces with computer bus 200 so as to provide information stored in RAM 208 to CPU 202 during execution of the instructions in software programs such as an operating system, application programs, and interface drivers. More specifically, CPU 202 first loads computer-executable process steps from fixed disk 220, or another storage device into a region of RAM 208. CPU 202 can then execute the stored process steps from RAM 208 in order to execute the loaded computer-executable process steps. In addition, data such as gathered network performance statistics or other information can be stored in RAM 208, so that the data can be accessed by CPU 202 during the execution of computer-executable software programs, to the extent that such software programs have a need to access and/or modify the data.

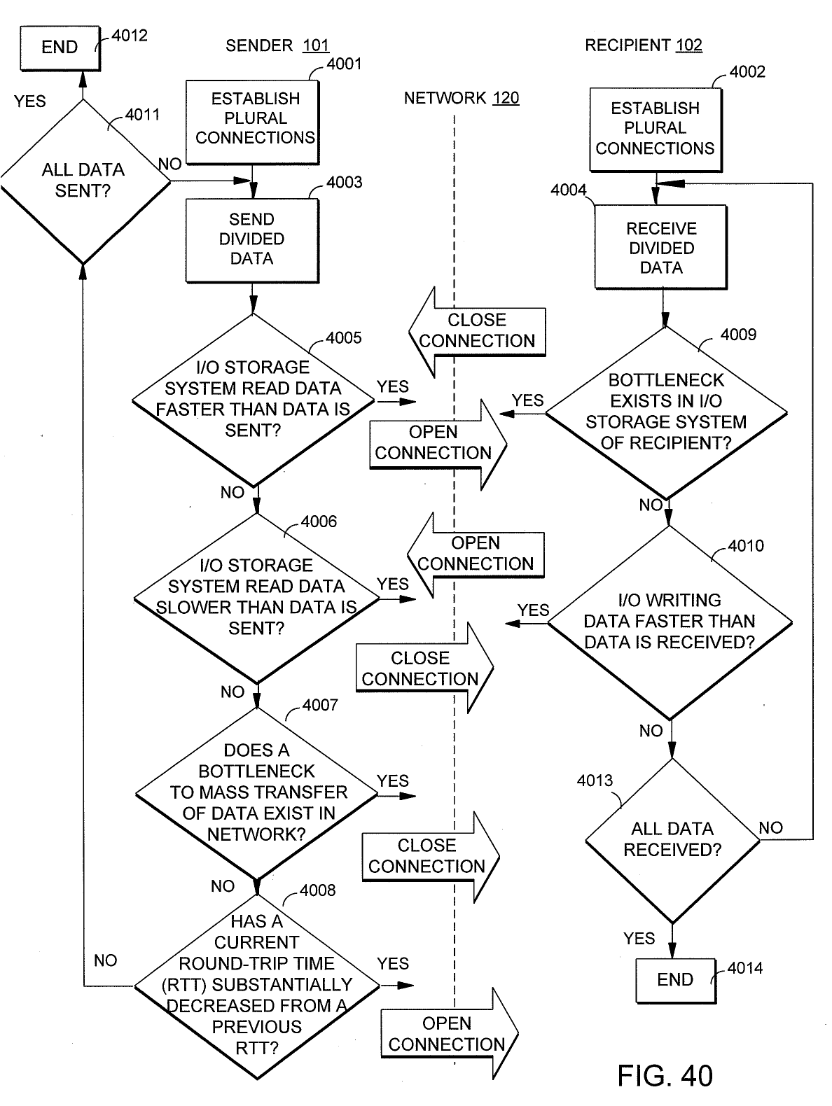

As also shown in FIG. 2, hard disk 220 contains operating system 228, application programs 230 such as programs for starting up and shutting down the sender 101, 131 or 132 or other programs. Hard disk 220 further contains network driver 232 for software interface to a network such as network 120. Hard disk 220 also contains streaming software 234 for controlling the sending of data from the sender. Lastly, hard disk 220 contains autotuning software 236 for controlling a number of connections between the sender 101 and the recipient 102, which will be described in greater detail below in connection with FIG. 40.

In an example embodiment, streaming software 234 and autotuning software 236 are loaded by CPU 202 into a region of RAM 208. CPU 202 then executes the stored streaming software 234 and autotuning software 236 from RAM 208 in order to execute the loaded computer-executable steps. In addition, application programs 230 are loaded by CPU 202 into a region of RAM 208. CPU 202 then executes the stored process steps as described in detail below in connection with FIG. 40, in order to execute the loaded computer-executable steps.

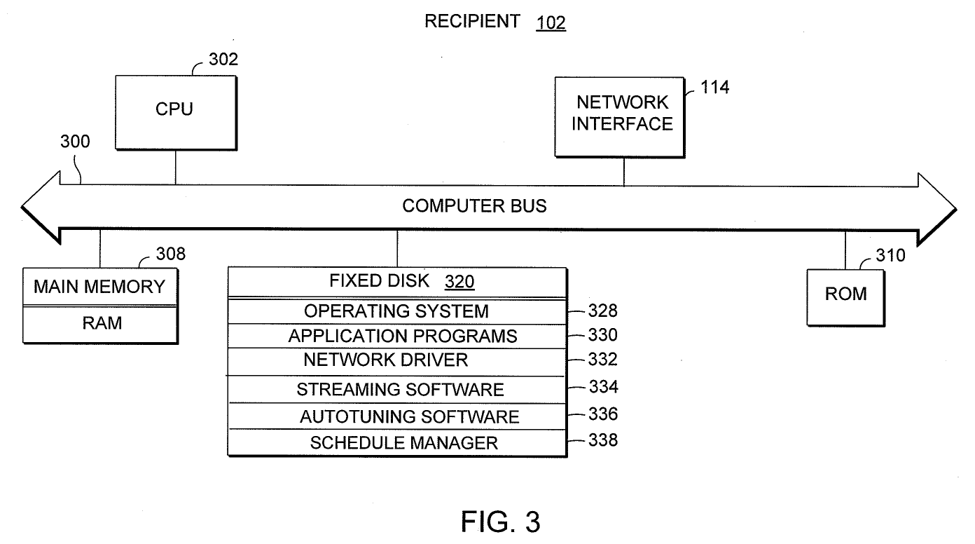

FIG. 3 is a detailed block diagram for explaining the internal architecture of the recipient 102 of FIG. 1. As shown in FIG. 3, recipient 102 includes central processing unit (CPU) 302 which interfaces with computer bus 300. Also interfacing with computer bus 300 are hard (or fixed) disk 320, network interface 114, random access memory (RAM) 308 for use as a main run-time transient memory, and read only memory (ROM) 310.

RAM 308 interfaces with computer bus 300 so as to provide information stored in RAM 308 to CPU 302 during execution of the instructions in software programs such as an operating system, application programs, and interface drivers. More specifically, CPU 302 first loads computer-executable process steps from fixed disk 320, or another storage device into a region of RAM 308. CPU 302 can then execute the stored process steps from RAM 308 in order to execute the loaded computer-executable process steps. In addition, data such as gathered network performance statistics or other information can be stored in RAM 308, so that the data can be accessed by CPU 302 during the execution of computer-executable software programs, to the extent that such software programs have a need to access and/or modify the data.

As also shown in FIG. 3, hard disk 320 contains operating system 328, application programs 330 such as programs for starting up and shutting down the recipient 102 or other programs. Hard disk 320 further contains network driver 332 for software interface to a network such as network 120. Hard disk 320 also contains streaming software 334 for controlling the receiving of data by the recipient 102. In addition, hard disk 320 contains a schedule manager 338 for scheduling different parameters with respect to connections between the sender 101 and the recipient 102, which will be described in greater detail in connection with FIG. 40. Lastly, hard disk 320 contains autotuning software 336 for controlling a number of connections between the sender 101 and the recipient 102, which will also be described in greater detail below in connection with FIG. 40.

The schedule manager 338 can perform many roles. For example, the schedule manager 338 can perform the role of keeping track of priorities assigned to various data transfer jobs/sessions. In addition, the schedule manager 338 can perform the role of governing a number of connections that a data transfer session can open. In particular, the schedule manager 338 maintains a job queue to keep track of a current number of connections between a sender and a recipient for a given data transfer. Furthermore, the schedule manager 338 can perform the role of defining a start time at which a given number of connections can be opened between a sender and a recipient. Lastly, the schedule manager 338 can perform the role of defining a time period or duration for which a given number of connections could be started and kept open, and terminating connections after the time period has elapsed. These roles will be described in greater detail below in connection with FIG. 40.

When performing the foregoing described roles, the schedule manager 338 uses certain criterion, for example, user defined priorities and system load defined priorities, to make certain decisions within each role. One example for a user defined priority is giving preference to a high paying customer's data transfer over a low paying customer. Some examples of system load defined priorities include keeping the system loaded enough so as not to break all of the data transfers, efficient utilization of bandwidth and system resources so that there is not under utilization, a fair load balancing scheme (if the user wants to use this scheme for data transfer), and preferring long running data transfers over short term data transfers or giving more connections to short running data transfers so that they perform their transfer first and exit without having to wait for long running data transfers to finish.

In order to facilitate the schedule manager 338 in performing the foregoing described roles, the following information is made available to the schedule manager 338: an available bandwidth between a given sender and a recipient, a data size for a given data transfer job, priorities assigned to different senders, and recommendations from the autotuning software 336 regarding a number of permissible connections based on the performance of a current CPU load, a current memory load, a current load on a disk or any disk related bottlenecks to transfer of data, and a current load on a network or any network related bottlenecks to transfer of data.

In an example embodiment, streaming software 334, autotuning software 336, and schedule manager 338 are loaded by CPU 302 into a region of RAM 308. CPU 302 then executes the stored process steps of the streaming software 334, autotuning software 336, and schedule manager 338 from RAM 308 in order to execute the loaded computer-executable steps. In addition, the process steps of the application programs 330 are loaded by CPU 302 into a region of RAM 308. CPU 302 then executes the stored process steps as described in detail below in connection with FIG. 40, in order to execute the loaded computer-executable steps.

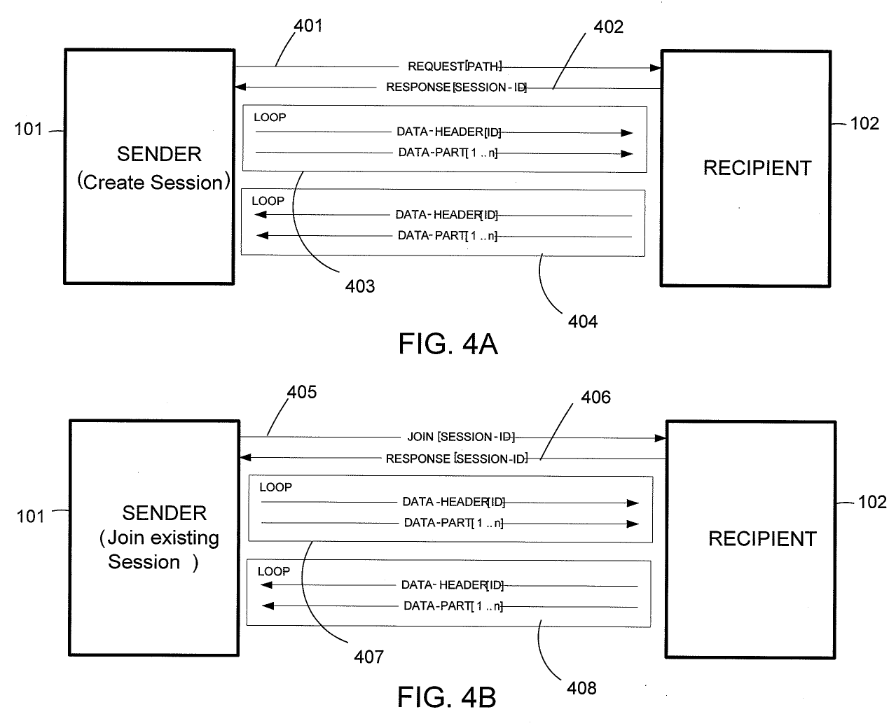

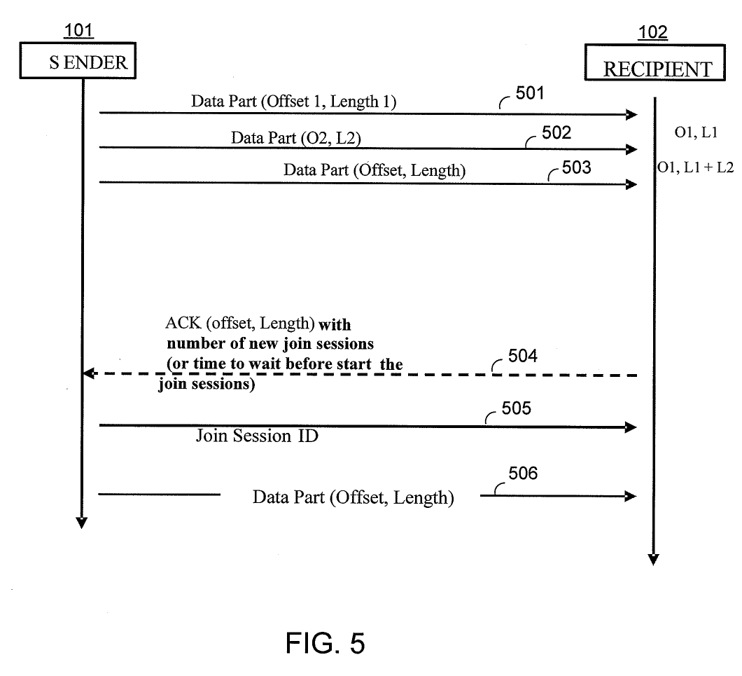

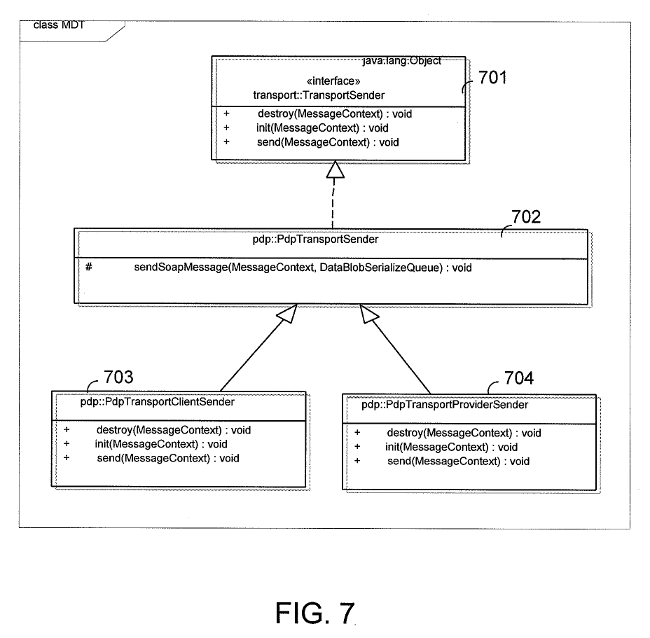

FIG. 4A is a view of a sender and a recipient for explaining an establishment of a primary connection between a sender and a recipient, according to an example embodiment. Generally, a parallel data protocol (PDP) is provided that utilizes multiple Transmission Control Protocol (TCP) connections via multiple sockets to send and receive data between the sender 101 and the recipient 102. However, other multiple connection systems (i.e., any logical connection endpoint over any connection-oriented protocol) for multi-stream data transport may be utilized, so long as the recipient collects data into a memory buffer before the data is written into a storage system, which will be described in greater detail below in connection with FIG. 6. In FIG. 4A, only sender 101 is shown; however, in other example embodiments, more than one sender may be forming connections with recipient 102 such as senders 131 and 132.

In FIG. 4A, the example PDP implemented is a proprietary, light-weight binary request/response based protocol which allows for sending and receiving of data via multiple streams (e.g., TCP connections). Before actual data transfer can occur, the sender 101 first sends a request message to the recipient 102 (401). The request message includes a requested URI (path) that is registered with the receiver 102. When the recipient 102 receives a valid request message, the recipient 102 replies with a response message that includes a unique session id assigned by the recipient 102 which can be used by the sender 101 for opening up data transfer connections (402). The foregoing described steps 401 and 402 start a first socket at the recipient 102 to establish a session for transferring data.

In the response message sent by the recipient 102, the recipient 102 includes a number of connections which the sender 101 is allowed to join in the established session. If the sender 101 attempts to join more than the provided number of connections, the recipient 102 can reject the additional join requests. In addition, the response message can include a length of life time for the established session. After expiration of the included life time, the sender 101 stops and terminates the session.

If the recipient 102 is busy, the recipient 102 returns to the sender 101a time period to wait before attempting to create the session again. The sender 101 then sends the subsequent create session request based on the time given by the recipient 102. If the sender 101 sends the subsequent create session request before the specified time period has expired, the recipient 102 will reject the request for creating the session.

Once the session is created, data can then be sent from the sender 101 to the recipient 102 (403), and data can be sent from the recipient 102 to the sender 101 (404). The data sent between the sender 101 and the recipient 102 includes a data-header id and a number of data parts to be sent.

FIG. 4B is a view of a sender and a recipient for explaining an establishment of a secondary connection between the sender and the recipient, according to an example embodiment. In FIG. 4B, during a given established session, as described above in FIG. 4A, a sender 101 can join the existing data-transfer session by sending a join request to open a new connection with the recipient 102 and by providing a valid session id (405). If the sender 101 provides a valid session id, then the recipient 102 returns a response message that includes a join session id (406). In addition, the response message can include a status change that includes the current session's time-alive and an updated list of join sessions.

Once the join session is created, data can be sent from the sender 101 to the recipient 102 (407), and data can be sent from the recipient 102 to the sender 101 (408). The data sent between the sender 101 and the recipient 102 includes a data-header id and a number of data parts to be sent.

In some cases, in step 406 of FIG. 4B, the recipient 102 may send a response message that rejects the join request from the sender 101. The recipient 102 may reject the join request, for example, because the request exceeds the number of connections allowed which was provided by the recipient in FIG. 4A. In these cases, the response message includes the number of connections allowed for the current session. In addition, the response message can include a time period (e.g., a number of seconds) that the sender 101 should wait before trying to join the session again. In this regard, the sender 101 may start a new join request after the number of seconds provided by the recipient 102 have passed.

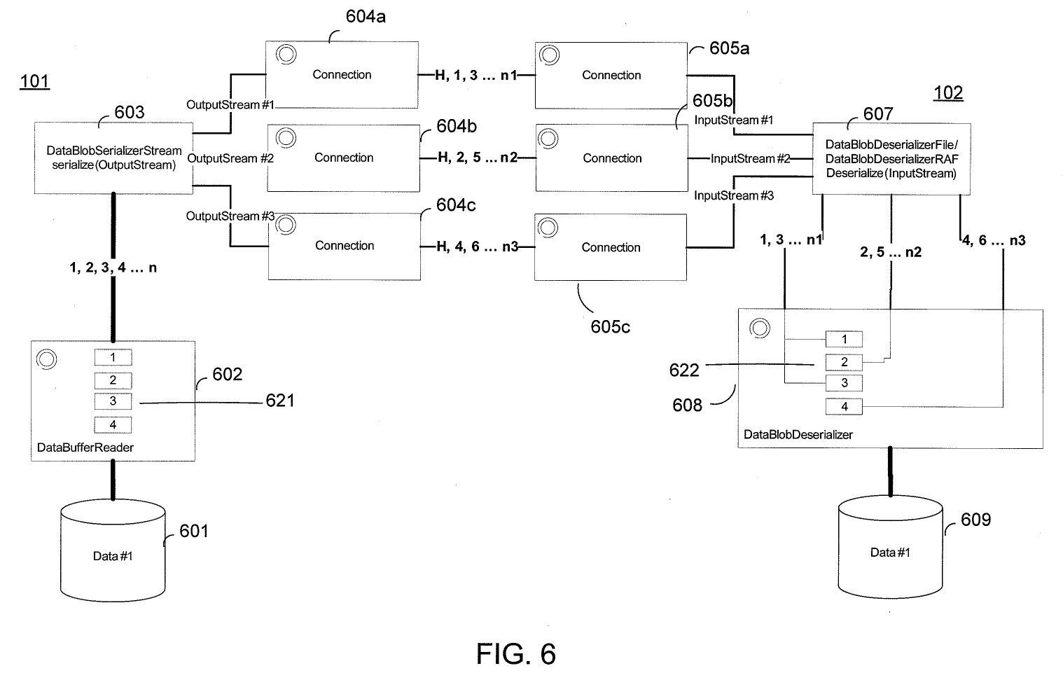

FIG. 5 is a sequence diagram for providing an explanation of a recipient notifying a sender to increase or decrease a number of connections in a session according to an example embodiment. In FIG. 5, the sender 101 sends a data part of offset 1, length 1 to the recipient 102 (501). The sender 101 then sends a data part of offset 2, length 2 to the recipient 102 (502), and continues to send data parts with subsequent offsets and lengths (503). The recipient 102 then determines whether the sender 101 can start more joins sessions, and sends an acknowledgment of the data parts received with an offset and length to the sender 101, together with a number of new join sessions and session id (504). The acknowledgment can also include a time period to wait before starting the new join sessions. The sender 101 then sends a join request with a session id (505), and once the session is created, the sender 101 sends another data part including an offset and length over the newly created join session (506).

In some cases, the recipient 102 may determine to close one or more existing connections. In these cases, the recipient sends an acknowledgment that the recipient 102 has closed one or more connections. Upon receipt by the sender 101 of an acknowledgment that one or more connections have been closed by the recipient 102, the sender 101 reacts to the acknowledgment by reapportioning the data sent over the remaining open connections.

FIG. 6 is another view of a sender and a recipient for providing a general explanation of sending data from the sender to the recipient according to an example embodiment. In FIG. 6, sender 101 includes an I/O storage system that includes a storage medium 601 such as a disk that stores data, a data buffer reader 602 that includes a data buffer 621, and a data blob serializer 603 for transmitting data. The sender 101 is connected to the recipient 102 via connections 604a and 605a, via connections 604b and 605b, and via connections 604c and 605c. The recipient 102 includes an I/O storage system that includes a storage medium 609 such as a disk, a data blob deserializer 608 that includes a data buffer 622, and a data blob deserializer file 607 for receiving transmitted data.

In FIG. 6, actual reading of source data is accomplished asynchronously using a separate thread that fills in the storage medium 601 with data to be transmitted by the sender 101. Data is read from the storage medium 601 by the data buffer reader 602 and stored in the data buffer 621. Each sender connection 604a, 604b and 604c de-queues a next available data chunk from the data buffer 621. The data buffer reader 602 reads data from the data buffer 621, and the data blob serializer 603 transmits the next available data chunk over the particular connection that de-queued the next available data chunk. The transmitted data chunk is received over the corresponding one of the recipient connections 605a, 605b and 605c. The data blob deserializer file 607 receives the transmitted data chunks from the recipient connections 605a, 605b and 605c. The data blob deserializer 608 stores the data in the data buffer 622, and re-creates the original file by putting the data chunks into the correct order. The data blob deserializer 608 then uses a background thread to write data to the storage medium 609.

For performance reasons, the data blob deserializer 608 caches some data in the data buffer 622, preferring to write data to the storage medium 609 when the data is placed in the original ordering. In some cases, when the ordering of data sent across different connections becomes far out of order, the data blob deserializer 608 will seek to different positions in the output file and write data to the storage medium 609 to prevent exhausting process memory with cached data.

### Mass Data Transfer-Parallel Data Protocol (MDT-PDP)

In an example architecture described herein, an MDT-PDP transport component acts as a transport handler for a Soap Connection Library (SCL) subsystem within an application. This includes transferring SOAP requests and responses. The MDT-PDP transport is functionally equivalent to the SCL's default HTTP-based transport from the point-of-view of an SCL client and an SCL service. However, the disclosure provided herein is not limited to the foregoing example architecture, and any transport protocol may be implemented so long as the features of the claims are achieved.

The objective of the SOAP Connection library is to offer provider (i.e., recipient) function and client function of the SOAP message based Web service. The provider function is a function that provides the Web service to execute specific processes and provide information for accessing. Whereas, the client function is a function to access the Web service. The Web service using SOAP Connection Library is not only the client using SOAP Connection Library but it also enables the processing of a request from the client that uses Microsoft .NET Framework and other Web service frameworks. Similarly, the client function is not only the Web service using SOAP Connection Library, but it enables the execution of a request related to Web service that uses .NET Framework and other Web service frameworks.

In the example architecture described herein, MDT-PDP implements the transport handler interfaces defined inside SCL. They are PdpTransportReceiver and PdpTransportSender on each of the sender and the recipient side. The PdpTransportSender on the sender side is responsible for establishing a PDP sender session with parallel connections between the PDP sender and the PDP recipient. Invocation of these handlers inside the handler chain depends upon the direction of flow of the data and the initiator. Invocation of these handlers inside the handler chain is also linked with the start and end of data transfer at the underlying PDP layer.

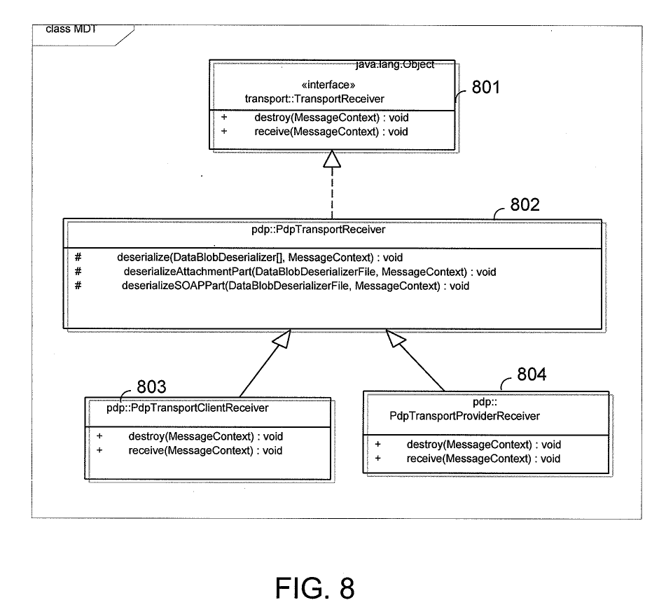

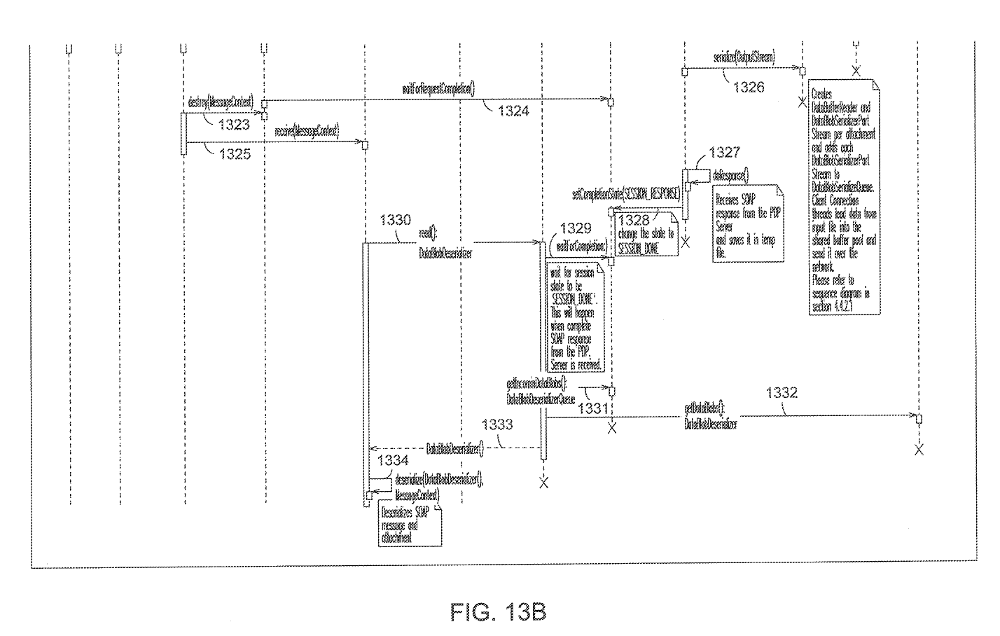

FIGS. 7 to 12 are class diagrams for each of the major classes that form an architecture of an example embodiment. A description with respect to the particular relationships and interaction between each of the major classes is provided in detail below in connection with FIGS. 13 to 20.

FIG. 7 is a class diagram for a transport sender according to an example embodiment. As shown in FIG. 7, a pdp::PdpTransportClientSender object 703 and a pdp::PdpTransportProviderSender object 704 each inherit a pdp::PdpTransportSender object 702. In addition, the pdp::PdpTransportSender object 702 implements a transport::TransportSender object 701 of the SCL library. The send( ) method, in class diagram of FIG. 7, sends the message over the transport layer with MessageContext object. This method is called when it deals with the transmission of the message.

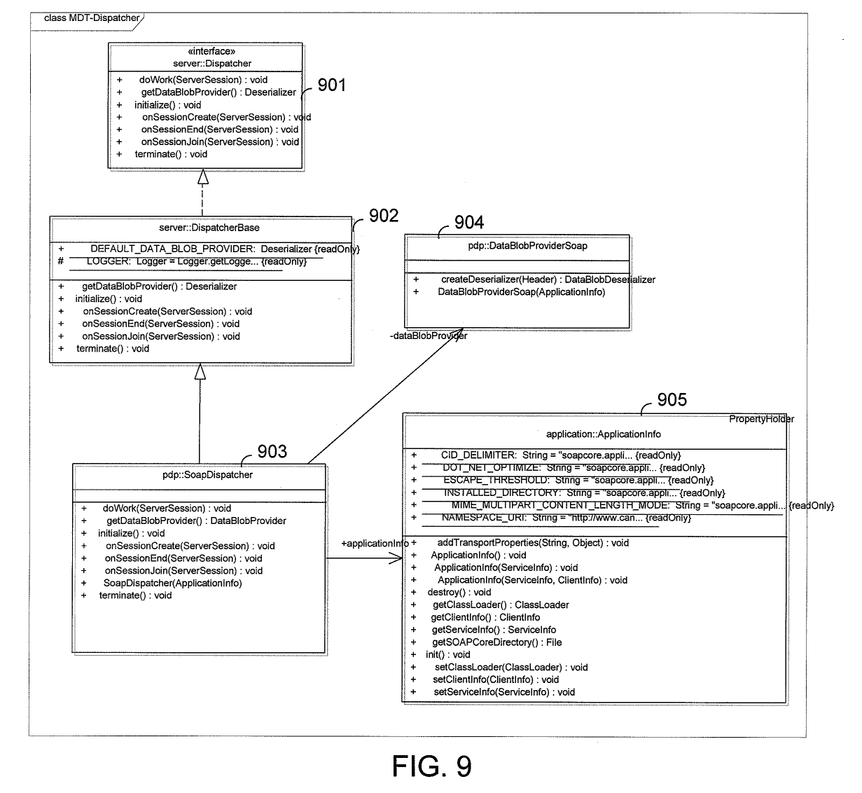

FIG. 8 is a class diagram for a transport receiver according to an example embodiment. As shown in FIG. 8, a pdp::PdpTransportClientReceiver object and a pdp::PdpTransportProviderReceiver object 804 each inherit a pdp::PdpTransportReceiver object 802. In addition, the pdp::PdpTransportReceiver object 802 implements a transport::TransportReceiver object 801. This receive( ) method receives a message from the transport layer, and performs management to store the various information of the received message in the Message class for the receipt.

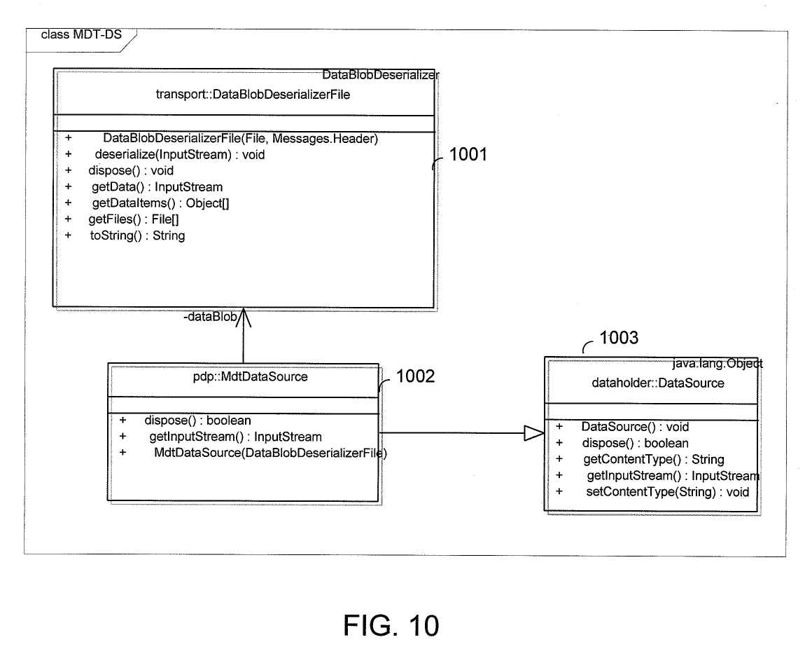

FIG. 9 is a class diagram for a server dispatcher according to an example embodiment. As shown in FIG. 9, a pdp::SoapDispatcher object 903 inherits a server::DispatcherBase object 902, and depends on a pdp::DataBlobProviderSoap object 904 and an application::ApplicationInfo object 905. In addition, the server::DispatcherBase object 902 depends on a server::Dispatcher object 901. The SoapDispatcher class contains an ApplicationInfo object which maintains information, such as operation information and client information when a user creates a service or client with Soap Connection Library. Therefore, the SoapDispatcher can communicate with SCL with the ApplicationInfo object and SCL contains a DispatcherHandler (not shown) to different type of dispatch handler in a DispatchHandlerChain object (not shown).

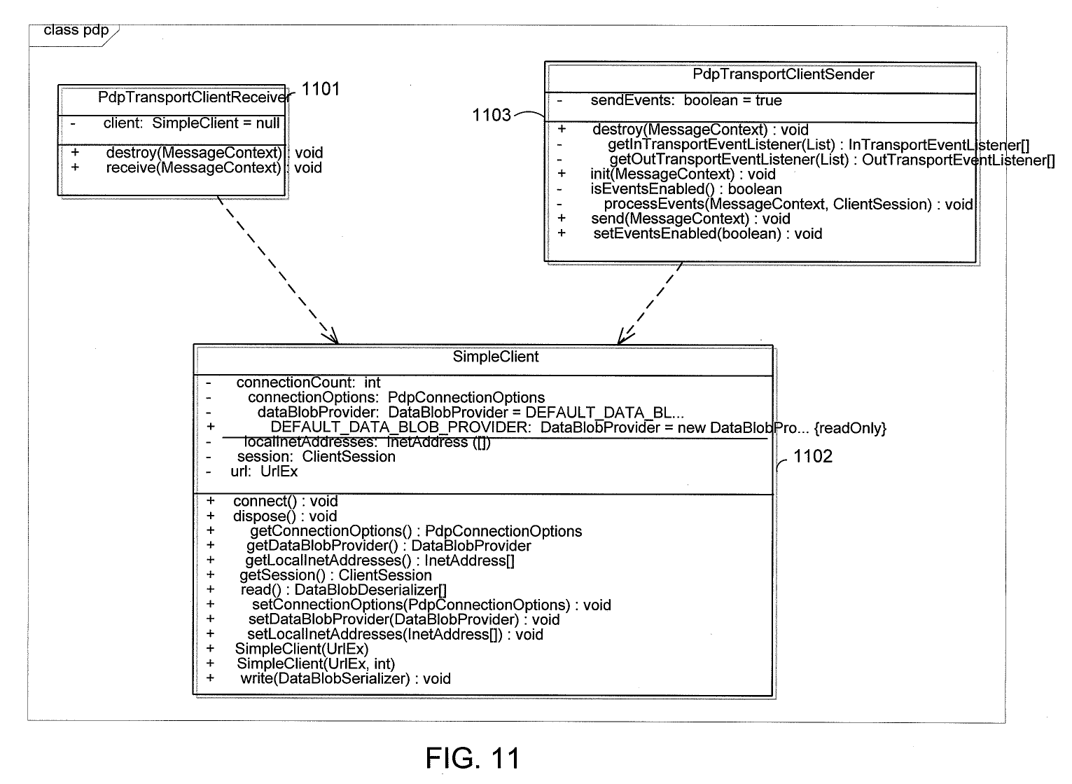

FIG. 10 is a class diagram for a data source according to an example embodiment. As shown in FIG. 10, a pdp::MdtDataSource object 1002 inherits a dataholder::DataSource object 1003 and associates with a transport::DataBlobDeserializerFile object 1001. The DataSource object contains functionality to allow caller to retrieve inputStream object where data is held.

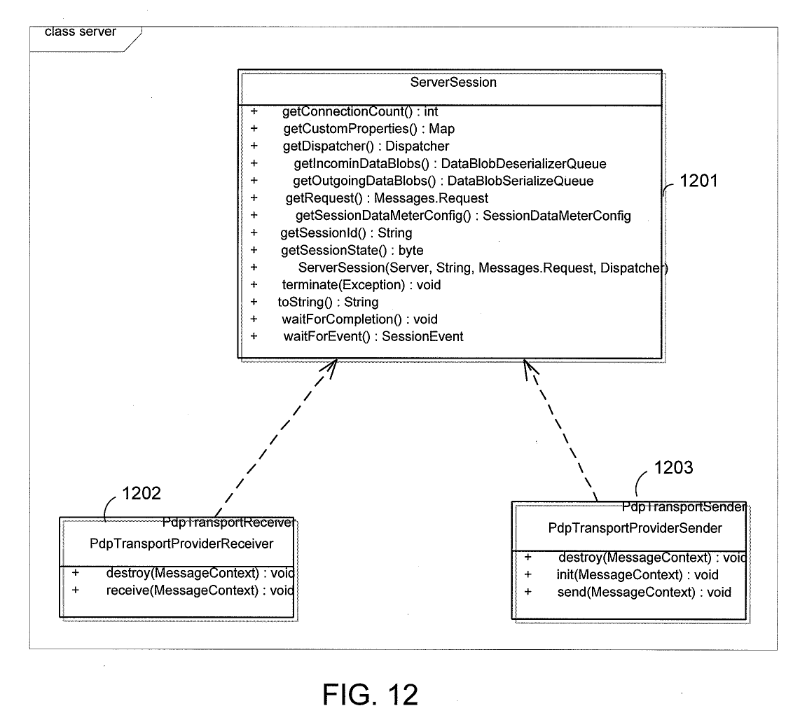

FIG. 11 is a class diagram for a client interaction according to an example embodiment. As shown in FIG. 11, each of a PdpTransportClientReceiver object 1101 and a PdpTransportClientSender object 1103 depend on a SimpleClient object 1102. The DataSource object contains client information for an MDT client.

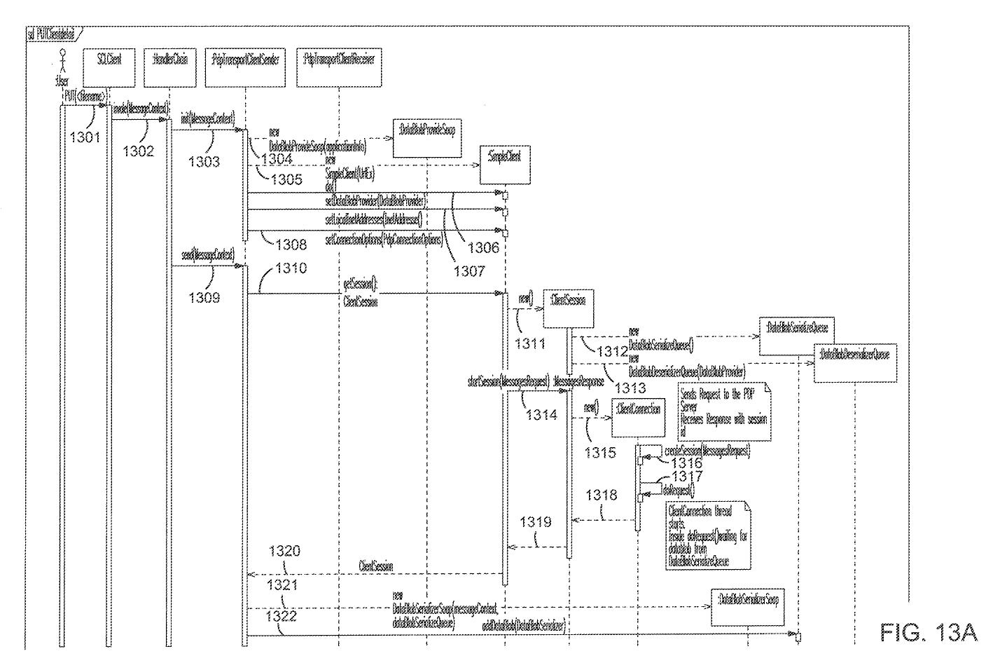

FIG. 12 is a class diagram for a server interaction according to an example embodiment. As shown in FIG. 12, each of a PdpTransportProviderReceiver object 1202 and a PdpTransportProviderSender object 1203 depend on a ServerSession object 1201. The ServerSession defines a server session of a PDP server.

FIGS. 13A and 13B are a sequence diagram at a client side in “put” scenario. As shown in FIG. 13A, in 1301, an SCLClient object inherits a PUT(<filename>) from a user. In 1302, a :HandlerChain object inherits an invoke(MessageContext) from the SCLClient object. In 1303, a :PdpTransportClientSender inherits an init(MessageContext) from the :HandlerChain object. In 1304 and 1305, the :PdpTransportClientSender object associates with a :DataBlobProviderSoap object and a :SimpleClient object. In 1306, 1307 and 1308, the :SimpleClient object inherits a setDataBlobProvider(DataBlobProvider), a setLocalInetAddresses(inetAdress[ ]), and a setConnectionOptions(PdpConnectionOptions) from the :PdpTransportClientSender object. In 1309, the :PdpTransportClientSender object inherits a send(MessageContext) from the :HandlerChain object. The SCLClient object acts as a SOAP client that utilizes MDT and PDP protocols to send and receive SOAP messages over this custom transport. The SimpleClient object is a “simple” component that allows a sender to utilize the PDP protocol to send data over multiple connections. Also, for the “PUT” operation, a sender sends data to a recipient (i.e., provider). For the “GET” operation, a sender retrieves data from a provider (i.e., recipient).

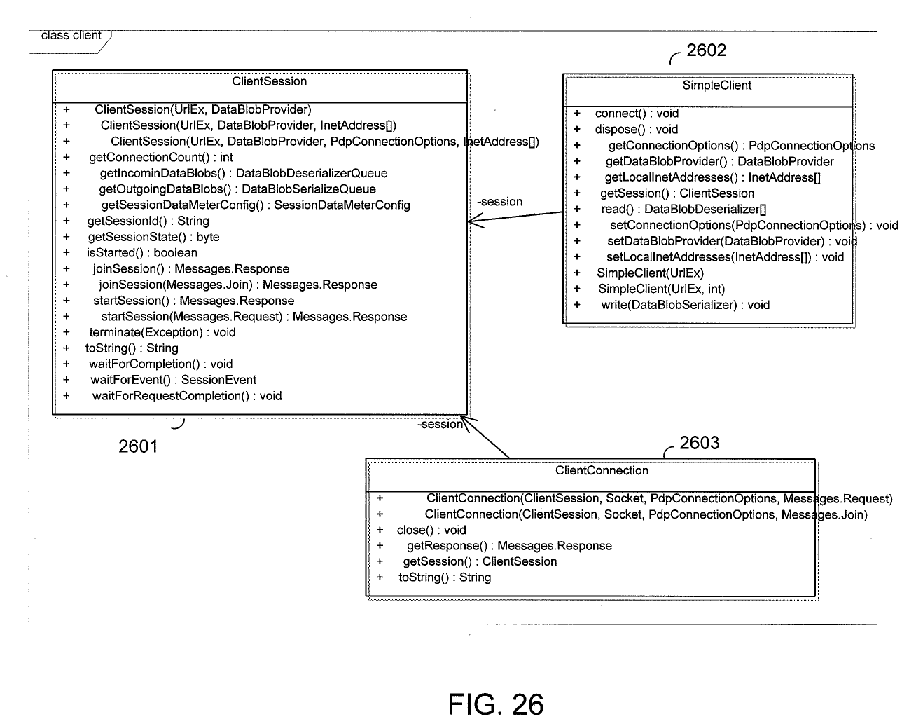

In 1310, the :SimpleClient object inherits a getSession( ):ClientSession from the :PdpTransportClientSender object. In 1311, the :SimpleClient object associates with a :ClientSession object, and in 1312 and 1313, the :ClientSession object associates with a :DataBlobSerializeQueue object and a :DataBlobDeserializeQueue object. In 1314, the :ClientSession object inherits a startSession(MessageRequest):MessagesResponse from the :SimpleClient object. In 1315, the :ClientSession object associates with a :ClientConnection object. In 1316 and 1317, the :ClientConnection object inherits a createSession(MessageRequest) and a doRequest( ) from itself. In 1318, the :ClientConnection object associates with the :ClientSession object. In 1319, the :ClientSession object associates with the :SimpleClient object. In 1320, the :SimpleClient object associates with the :PdpTransportClientSender object. In 1321, the :PdpTransportClientSender object associates with a :DataBlobSerializerSoap object. In 1322, the :DataBlobSerializeQueue object inherits an addDataBlob(DataBlobSerializer) from the :PdpTransportClientSender object. In 1323, the :PdpTransportClientSender object inherits a destroy(MessageContext) from the :HandlerChain object, and in 1324, the :ClientSession object inherits a waitForRequestCompletion( ) from the :PdpTransportClientSender object. In 1325, a :PdpTransportClientReceiver object inherits a receive(MessageContext) from the :HandlerChain object. It should be noted that the DataBlobSerializerSoap class extends the DataBlobSerializer (see, e.g., FIG. 27 described below) and utilizes an SCL MessageSerializer object to serialize a message in a MessageContext object. The DataBlobSerializer defines a data-blob serializer as an abstract class which also is extended by DataBlobSerializerNoData and DataBlobSerializerPartStream described in more detail below.

In 1326, the :DataBlobSerializerSoap object inherits a serialize(OutputStream) from the :ClientConnection object. In 1327, the :ClientConnection object inherits a doReponse( ) from itself. In 1328, the :ClientSession object inherits a setCompletionStatus(SESSION_RESPONSE_from the :ClientSession object). In 1330, the :SimpleClient object inherits a read( ): DataBlobDeserializer from the :PdpTransportClientReceiver object. In 1329, the :ClientSession object inherits a waitForCompletion( ) from the :SimpleClient object. In 1331, the :ClientSession object inherits a getIncominDataBlobs: DataBlobDeserializerQueue from the :SimpleClient object. In 1332, the :DataBlobDeserializerQueue object inherits a getDataBlobs( ): DataBlobDeseralizer from the :SimpleClient object. In 1333, the :SimpleClient object associates with the :PdpTransportClientReceiver. In 1334, the :PdpTransportClientReceiver inherits a deseriliaze(DataBlobDeserializer[ ]MessageContext) from itself.

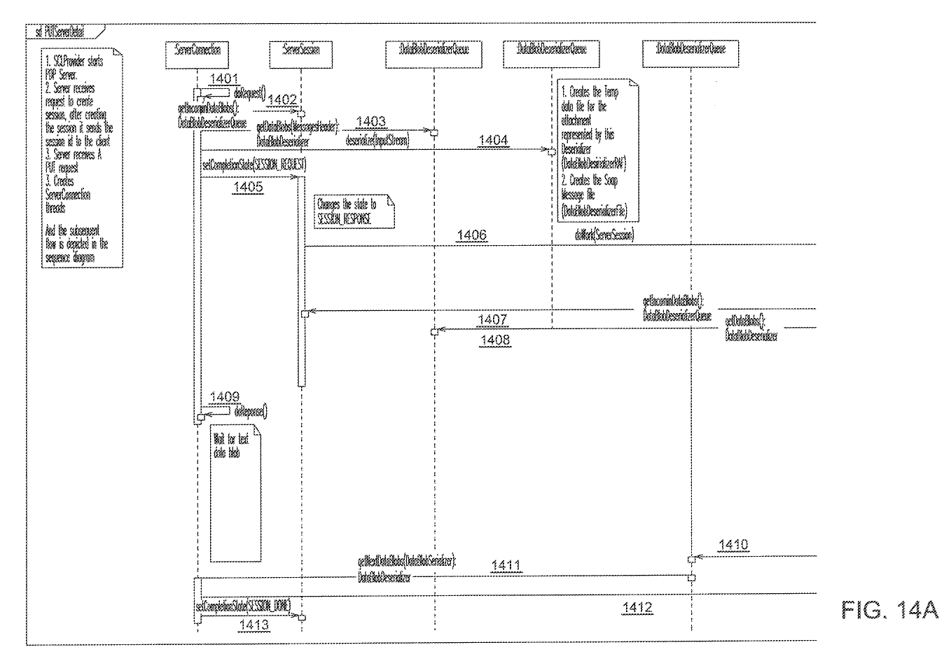

FIGS. 14A and 14B are a sequence diagram at a provider side in a “put” scenario. As shown in FIG. 14A, a :ServerConnection object inherits a doRequest from itself. In 1402, a :ServerSession inherits a getIncominDataBlobs( ): DataBlobDeserializeQueue from the :ServerConnection object. In 1403 and 1404, a :DataBlobDeserializerQueue object and a :DataBlobDeserializer object inherit a getDataBlob(MessagesHeader): DataBlobDeserializer and a deserialize(InputStream) from the :ServerConnection object. In 1405, the :ServerSession object inherits a setCompletionState(SESSION_REQUEST) from the :ServerConnection object. In 1406, a :SoapDispatcher object inherits a doWork(ServerSession) from the :ServerSession object. In 1414, a :HandlerChain inherits an invoke(MessageContext) from the :SoapDispatcher object. In 1415, a :PdpTransportProviderReceiver inherits a receive(MessageContext) from the :HandlerChain object. In 1407 and 1408, the :ServerSession object and the :DataBlobDeserializerQueue inherit a getIncominDataBlobs( ): DataBlobDeserializerQueue and a getDataBlobs( ): DataBlobDeserializer from the :PdpTransportProviderReceiver object. It should be noted that the DataBlobDeserializerFile class implements a file based data-blob deserializer. The DataBlobDeserializerQueue class implements a data-blob deserializer queue. A DataBlobDeserializerRAF class's implementation is one that deserializes data parts to a single file. This DataBlobDeserializerRAF implementation uses a RandomAccessFile (“RAF”) to write out data parts. Furthermore, writing to disk and reading from input streams are decoupled though use of an in-memory data-part buffer and a background writer thread. The ServerConnection class includes a PDP Server and session info of the PDP server. It's caller can create and start a PDP connection and receive and send messages via this class.

In 1409, the :ServerConnection object inherits a doResponse from itself. In 1416 and 1417, the :PdpTransportProviderReceiver inherits a deserializeSOAP(DataBlobDeserializeerFile, MessageContext) and a deserializeAttachment(DataBlobDeserializerRAF, MessageContext). In 1418, the :PdpTransportProviderReceiver object inherits a destroy(MessageContext) from the :HandlerChain object. In 1419 and 1420, a :PdpTransportProviderSender object inherits a init(MessageContext) and a send(MessageContext) from the :HandlerChain object. In 1421, the :PdpTransportProviderSender associates with a :DataBlobSerializerSoap object. In 1410, the :DataBlobSerializeQueue inherits a addDataBlob(DataBlobSerializer) from the :PdpTransportProviderSender object. In 1411, the :DataBlobSerializeQueue inherits a getNextDataBlob(DataBlobSerializer): DataBlobSerializer from the :ServerConnection object. In 1412, the :DataBlobSerializerSoap object inherits a serialize(OutputStream) from the :ServerConnection object. In 1413, the :ServerSession object inherits a setCompletionState(SESSION_DONE) from the :ServerConnection object.

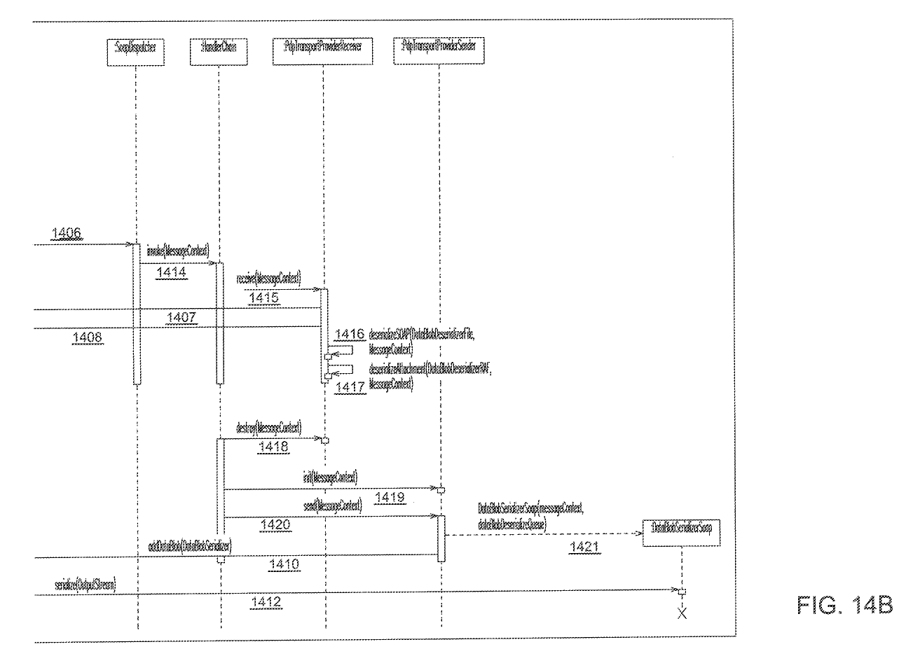

FIG. 15 is a sequence diagram at a client side in a “get” scenario. As shown in FIG. 15, in 1501, a SCLClient object inherits a GET(<filename>) from a user. In 1502, a :HandlerChain object inherits a Invoke(messagecontext) from the SCLClient object. In 1503, a :PdpTransportClientSender object inherits an init(MessageContext) from the :HandlerChain object. In 1504, 1505 and 1506, a :SimpleClient object inherits a setDataBlobProvider(DataBlobProvider), a setLocalInetAddress(InetAddress[ ]), and a setConnectionOptions(PdpConnectionOptions) from the :PdpTransportClientSender object. In 1507, the :PdpTransportClientSender object inherits a send(MessageContext) from the :HandlerChain object. In 1508, the :SimpleClient object inherits a getSession( ) :ClientSession from the :PdpTransportClientSender object. In 1509, the :PdpTransportClientSender object inherits a sendSoapMessage(MessageContext, DataBlobSerializeQueue) from itself. In 1510, the :PdpTransportClientSender object inherits a destroy(MessageContext) from the :HandlerChain object. In 1511 and 1512, the :PdpTransportClientReceiver object inherits a receive(MessageContext) and a destroy(MessageContext) from the :HandlerChain object.

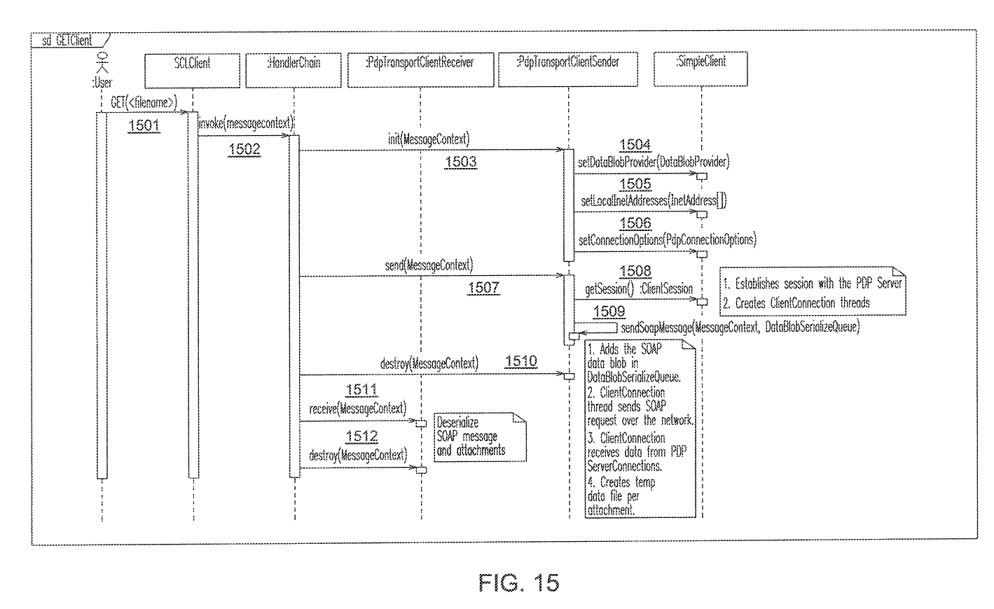

FIG. 16 is a sequence diagram at a provider side in a “get” scenario. As shown in FIG. 16, in 1601, a :SoapDispatcher object inherits a doWork(ServerSession) from a :ServerSession object. In 1602, a :HandlerChain object inherits an invoke(messageContext) from the :SoapDispatcher object. In 1603 and 1604, a :PdpTransportProviderReceiver inherits a receive(MessageContext) and a destroy(MessageContext) from the :HandlerChain object. In 1605 and 1606, a :PdpTransportProviderSender object inherits an init(MessageContext) and a send(MessageContext) from the :HandlerChain object. In 1607, the :PdpTransportProviderSender inherits a sendSoapMessage(MessageContext, DataBlobSerializeQueue) from itself. In 1608, the :PdpTransportProviderSender object inherits a destroy(MessageContext) from the :HandlerChain object.

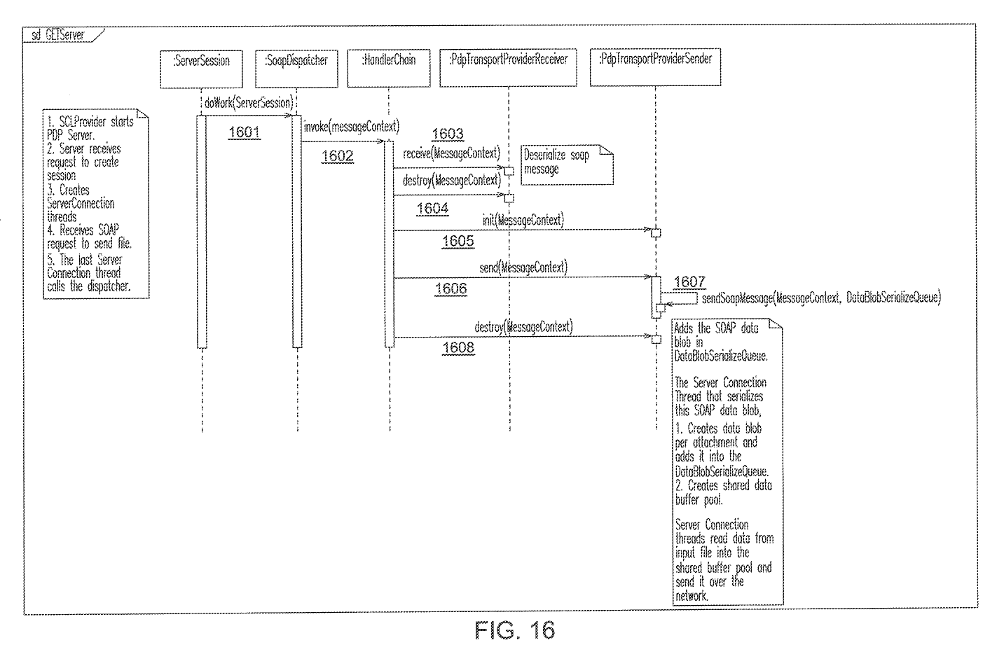

FIG. 17 is a sequence diagram at a client side for cancelling a “get” operation. As shown in FIG. 17, in 1701, a :ClientSession object inherits a start a new session( ) from a :PdpTransportClientSender object. In 1702, a :ClientConnection object inherits a start the connection (socket thread) from the :ClientSession object. In 1703, a :MeterinputStream object inherits a *read(byte[ ], int, int):int from the :ClientConnection object. In 1704, a :SessionDataMeter object is instantiated by function *on BytesRead(long) in the :MeterInputStream object. In 1705, the :SessionDataMeter object associates a SessionEvent( ) with the :PdpTransportClientSender. In 1706, an <<interface>>:InTransportEventListener object inherits a handlelnTransportEvent(InTransportEvent) from the :PdpTransportClientSender object. In 1707, the <<interface>>:InTransportEventListener object associates a throw IOException( ) with the :PdpTransportClientSender object. In 1708, the :ClientSession object inherits a terminate(Exception) from the :PdpTransportClientSender object. In 1709, the :ClientConnection object inherits a close( ) from the :ClientSession object. The MeterinputStream object updates data bytes received by utilizing a SessionDataMeter object, by calling function on BytesRead(long) in the SessionDataMeter object.

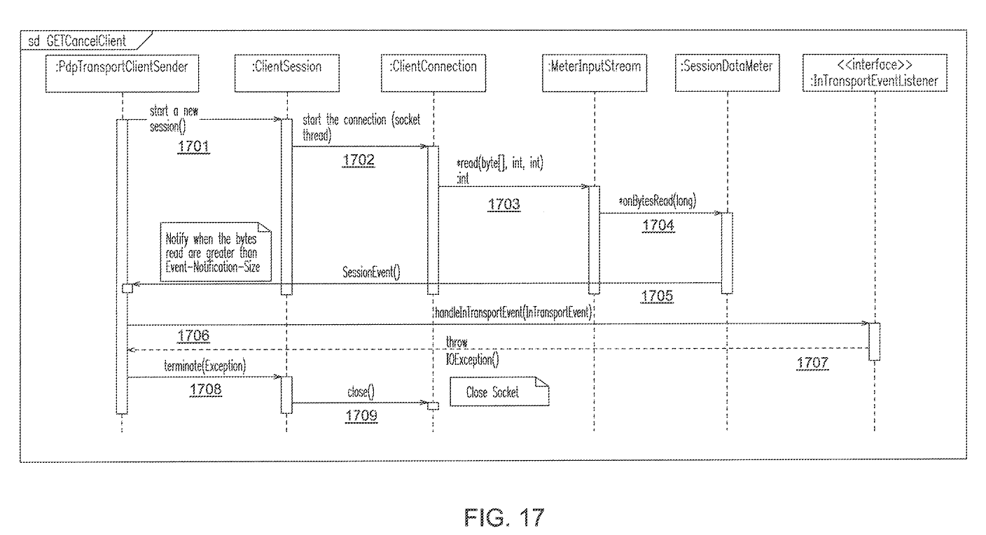

FIG. 18 is a sequence diagram at a provider side for cancelling a “get” operation. As shown in FIG. 18, in 1801, a :ServerSession object inherits a Start a new server session( ) from a SoapDispatcher:eventProcessorThread. In 1802, a :ServerConnection object inherits a start a connection socket( ) from the :ServerSession object. In 1803, a :MeterOutputStream inherits a *write(byte[ ], int, int) from the :ServerConnection object. In 1804, a :SessionDataMeter object inherits a *on ByteWrite(long) from the :MeterOutputStream object. In 1805, the :SessionDataMeter associates a waitForEvent( ):SessionEvent with the SoapDispatcher:eventProcessorThread object. In 1806, an <<interace>>:OutTransportEventListener object inherits a handleOutTransportEvent(OutTransportEvent) from the SoapDispatcher:eventProcessorThread object. In 1807, a <<interface>>:OutTransportEventListener object associates with the SoapDispatcher:eventProcessorThread object. In 1808, the :ServerSession object inherits a terminate(Exception) from the SoapDispatcher:eventProcessorThread. In 1809, the :ServerConnection object inherits a close( ) from the :ServerSession object.

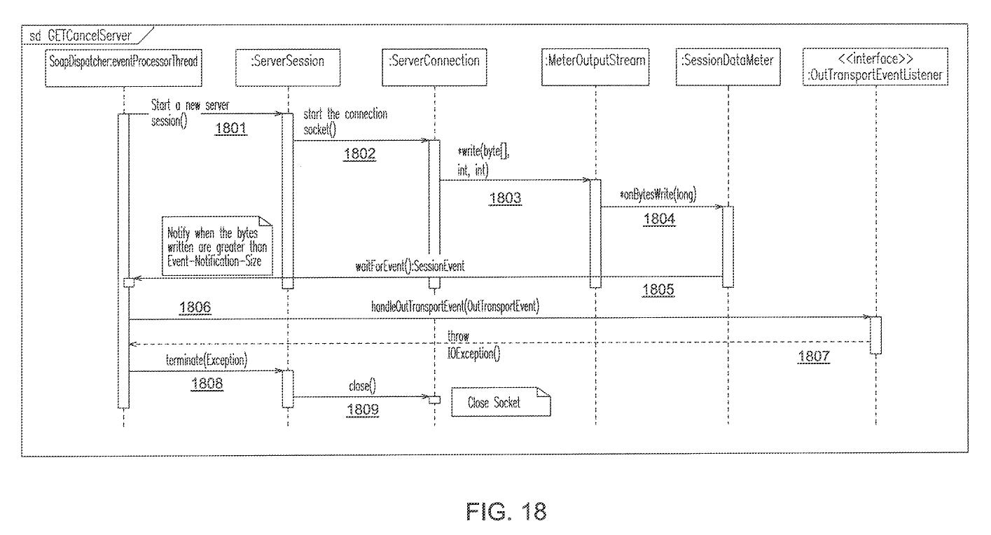

FIG. 19 is a sequence diagram at a client side for cancelling a “put” operation. As shown in FIG. 19, a :MeterOutputStream object inherits a write(byte[ ], int, int) from a :ClientConnection object. In 1902, a :SessionDataMeter object inherits an on BytesWrite(long). In 1903, the :SessionDataMeter object inherits a waitForEvent( ) :SessionEvent from a :PdpTransportClientSender object. In 1904, an <<interface>>:OutTransportEventListener object inherits a handleOutTransportEvent(OutTransportEvent) from the :PdpTransportClientSender object. In 1905, the <<interface>>:OutTransportEventListener object associates a throw IOException( ) with the :PdpTransportClientSender object. In 1906, a :ClientSession object inherits a terminate(Exception) from the :PdpTransportClientSender object. In 1907, the :ClientConnection object inherits a close 0 from the :ClientSession object.

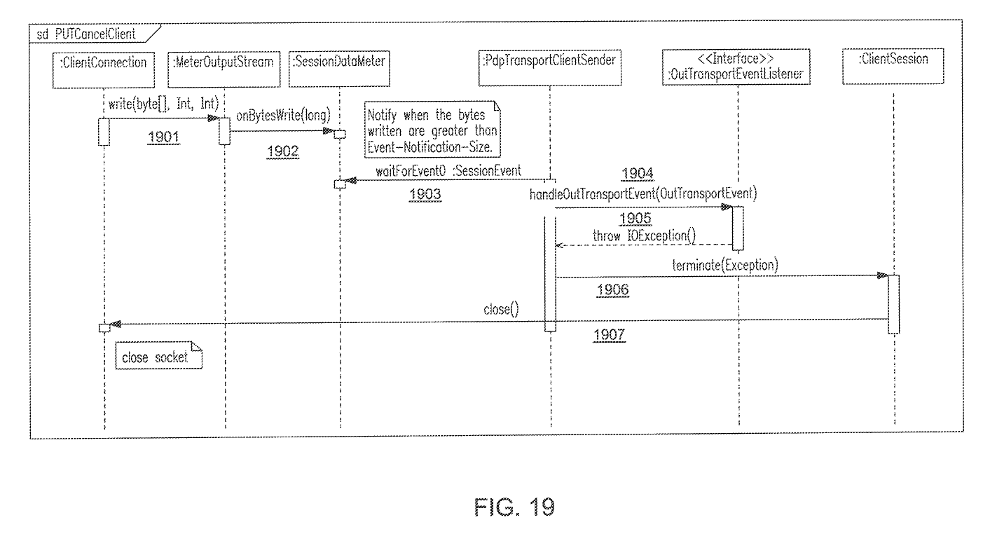

FIG. 20 is a sequence diagram at a provider side for cancelling a “put” operation. As shown in FIG. 20, a :MeterInputStream object inherits a read(byte[ ], int, int) from a :ServerConnection object. In 2002, a :SessionDataMeter object inherits an on BytesRead(long). In 2003, the :SessionDataMeter object inherits a waitForEvent( ) :SessionEvent from a SoapDispatcher:eventProcessorThread object. In 2004, an <<interface>>:InTransportEventListener object inherits a handlelnTransportEvent(InTransportEvent) from the SoapDispatcher:eventProcessorThread object. In 2005, the <<interface>>:InTransportEventListener object associates a throw IOException( ) with the SoapDispatcher:eventProcessorThread object. In 2006, a :ServerSession object inherits a terminate(Exception) from the SoapDispatcher:eventProcessorThread object. In 2007, the :ServerConnection object inherits a close 0 from the :ServerSession object.

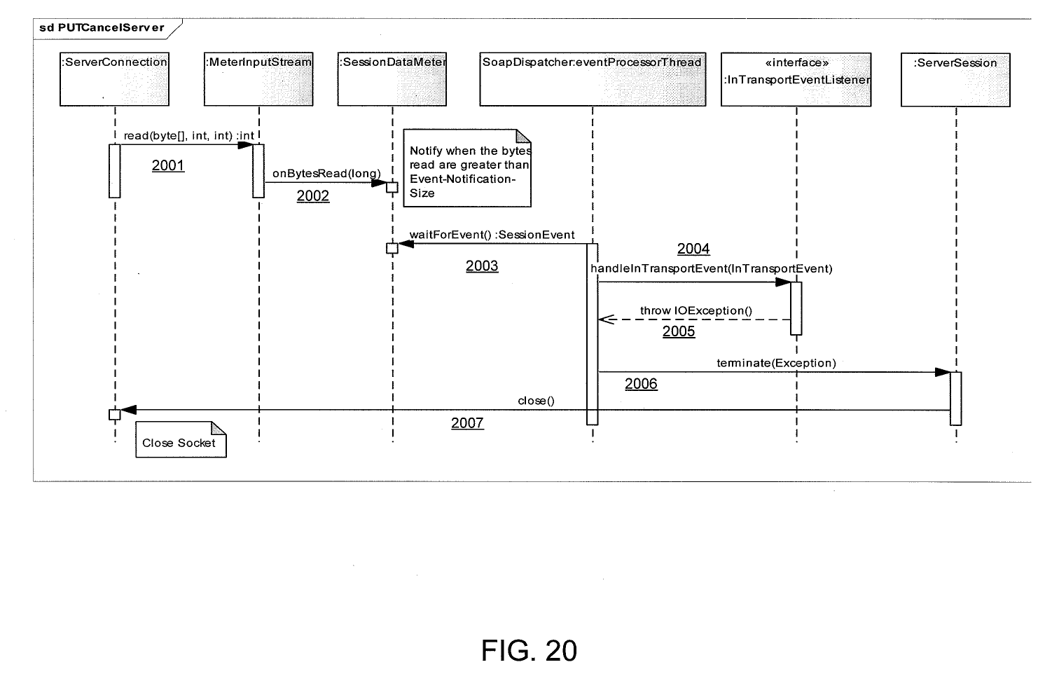

FIG. 21 is a representative view of a writing operation in an I/O storage system of the recipient 102 of FIG. 1. Generally, in a parallel connection data transfer system, the I/O storage system of the recipient can be a bottleneck to a mass transfer of data, and more particularly, a disk included in the I/O storage system can be a bottleneck to a mass transfer of data. In this regard, when a file is divided into small pieces or chunks and is delivered over separate connections, the data may not arrive in order at the recipient, especially as a number of connections is increased. If the recipient times out waiting for a next consecutive data chunk to arrive, before writing the data to a disk, a data buffer of the recipient may get full. If the data buffer of the recipient gets full, then the I/O storage system of the recipient may be forced to do a disk write for out of order data which might require additional seek operations. Performing additional seek operations would further increase a time it takes to transfer data if the I/O storage system of the recipient is a bottleneck to the transfer of data. In addition, the foregoing might also trigger data re-send events from the sender, due to lack of acknowledgments (i.e., for the data lost due to receiver buffers being full) adding further delays to the transfer of data. In this scenario, the recipient can stop accepting new connection requests, and can also reduce an existing number of connections to possibly avoid a full buffer condition, which in turn may avoid further costly seek operations.

When sending data over plural connections, a many-to-one relationship exists between the connections between the sender 101 and the recipient 102 and an output file. That is, data transferred in multiple concurrent connections is funneled into a single file. Within each connection at the recipient receiving data, a thread is started to read all data chunks from the inbound connection associated with the single file. An N number of parallel connections transferring chunks for the same file all invoke a deseralize method on the same data blob deserializer file 607 as shown in FIG. 6. The data blob deserializer's (of FIG. 6) task is then to read all data chunks associated with the file from all N connections, and transferring the data to the storage medium 609 of FIG. 6 in an efficient manner.

As shown in FIG. 21, a DataWriteQueue 2101 stores data in the form of DataWriteObjects which are represented by ovals. In FIG. 21, a writer thread 2102 writes the DataWriteObjects to a file. Reference number 2103 represents the beginning of the file. Moreover, data already written to the file is represented as reference number 2105. Areas 2106 represent areas in which data has already been received, but has not yet been written to the file. Areas 2107 represent areas where data has not yet been received. The DataWriteQueue is a threadsafe blocking queue implementation. Instance monitor is used as synchronization lock for remove( ) and insert( ) methods. They remove items from the queue. The removeDataWriteObjectWithOffset( ) method can be used to remove the change starting at a particular offset. This method will block until the required data block is available. The DataWriteObject object stores data in a memory buffer in a LinkList object to chain the data and it also records data offset and length information.

In FIG. 21, a current file position is available for the writer thread 2102 to write data to the file. However, it is possible that no such DataWriteObject is present in the DataWriteQueue 2101 for the current file position 2105. Since different connections are used to transport data from different areas of the file, it is possible for a particular area of the file to have not yet been received by the time the writer thread 2102 is ready to write that particular area of the file to disk. This may indicate that the memory buffer is not large enough to accommodate temporary chunk data before writing to storage, which in turn means that a seek operation might be performed. This usually means that data transfer rates from the sender 101 to the recipient 102 are faster compared to the processing I/O storage system. Thus, the number of join connections may be reduced to avoid a file seek operation, which will be described in more detail below in connection with FIG. 40.

More specifically, if the writer thread 2102 is allowed in this scenario to write a different area of the file to disk, then the writer thread 2102 will perform a seek operation which is to be avoided. On the other hand, if the writer thread 2102 blocks indefinitely, waiting an unlimited amount of time for a DataWriteObject to be presented to the queue by one of the connections, then there is potential for inefficiency as well. This is especially true when a faster network is employed and a disk of the I/O storage system is a bottleneck in the transfer of data. In this case, the more the writer thread 2102 is made to wait, the more inefficient the transfer becomes.

To provide an efficient PDP transfer of data, two things are balanced: (1) writing data to the disk frequently, which means allowing the writer thread 2102 to remain unblocked frequently, and (2) avoiding file seek operations, which means sometimes blocking the writer thread 2102 to wait until data for the current file position is read from one of the connections.

The above-mentioned balancing is performed in the DataWriteQueue 2101. When the DataWriteObject for the current file position 2104 is not available, the DataWriteQueue employs, for example, the following heuristic, which tends to substantially avoid unnecessary seek operations, and also tends to substantially avoid unnecessary blocking of the writer thread 2102: If a DataWriteObject is not available for the current file position: (1) Wait up to 2 seconds for the requested DataWriteObject to be added to the DataWriteQueue 2101 by a reader thread; (2) If the requested DataWriteObject becomes available within the 2 second timeout period, then return it; and (3) If the requested DataWriteObject does not become available within the 2 second timeout period, then return to the writer thread 2102 the DataWriteObject with the lowest absolute offset that is available. This heuristic attempts to balance keeping the writer thread writing to the disk against avoiding file seek operations. However, seek operations may not be avoided entirely, and for better performance of data transfer, the recipient 102 may block join requests from the sender 101 and request that the sender 101 close one or more secondary connections, which will be described in more detail below in connection with FIG. 40.

When there are fewer DataWriteObjects in memory (i.e., representing data not yet written to file by the writer thread 2102), it is less likely that a DataWriteObject representing the current file position 2104 is available. If the writer thread 2102 is allowed to write one of the available DataWriteObjects to file in this scenario, it is more likely to require a seek operation on the file. Therefore, when the DataWriteQueue 2101 is near empty, the writer thread 2102 is blocked when it tries to remove DataWriteObjects, so as to allow the DataWriteQueue 2101 to be filled to a minimum level by the connection reader threads.

In a different scenario, reader threads may be blocked when trying to add DataWriteObjects to the DataWriteQueue 2101. In this scenario, when the DataWriteQueue 2101 is filled with a very large number of DataWriteObjects, then a connection reader thread (not shown) that tries to add another DataWriteObject to the DataWriteQueue 2101 will be blocked. This allows the writer thread 2102 to write some of the DataWriteObjects to disk.

Internally, the DataWriteQueue 2101 utilizes a ConsumerProducerThrottle object (not shown) to decide when the foregoing described blocking scenarios have occurred. The ConsumerProducerThrottle object is an interface object that defines contracts for DataWriteObjectThrottle (not shown) to implement. The DataWriteObjectThrottle allows an application to configure memory buffer size for caching unrealized data in the memory before writing to disk storage and it also contains current and consumed recovery buffer information.

When the writer thread 2102 requests to remove a DataWriteObject from the DataWriteQueue 2101, the DataWriteQueue notifies the ConsumerProducerThrottle object of the request. The ConsumerProducerThrottle object blocks the writer thread 2102 if the DataWriteQueue 2101 does not have a minimum number of DataWriteObjects in it. Once the DataWriteQueue 2101 is filled with enough DataWriteObjects, the ConsumerProducerThrottle releases the writer thread 2102.

Alternatively, when the reader thread requests to add a new DataWriteObject to the DataWriteQueue 2101, it may be that the DataWriteQueue 2101 has reached a maximum number of DataWriteObjects. In this scenario, the reader thread is blocked until the writer thread 2102 has a chance to remove DataWriteObjects from the DataWriteQueue 2101. Again, the DataWriteQueue 2101 utilizes its ConsumerProducerThrottle object to decide when the foregoing scenario has occurred. When the reader thread adds a DataWriteObject to the DataWriteQueue 2101, the DataWriteQueue 2101 notifies the ConsumerProducerThrottle that DataWriteObject is being added. If the ConsumerProductThrottle decides that the DataWriteQueue 2101 has reached its maximum number of DataWriteObjects, then the ConsumerProductThrottle blocks the reader thread. The reader thread stays blocked until the number of DataWriteObjects in the queue is reduced.

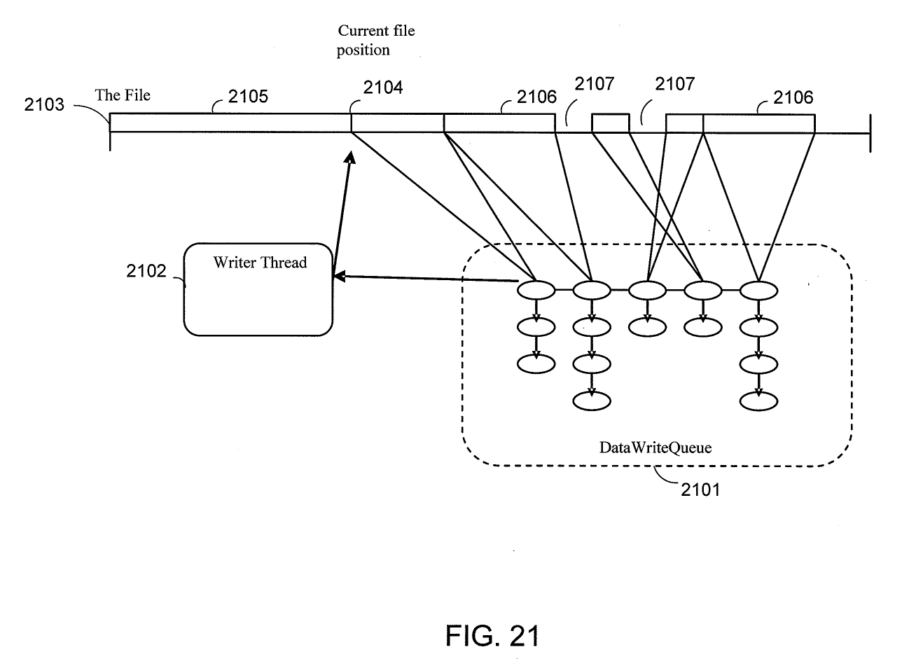

FIG. 22 is a representative view of the DataWriteQueue 2101 as shown in FIG. 21. In FIG. 22, the DataWriteQueue 2101 is shown after receiving several DataWriteObjects, for example, DataWriteObjects 2201a to 2201d. In this example, the DataWriteObjects are organized into 5 chains, representing 5 contiguous areas of the file. DataWriteObjects 2201a to 2201d represent one of the five chains. Generally, the DataWriteQueue 2101 acts as a synchronization and organization point for the N reader threads. To avoid seek operations, the DataWriteQueue automatically detects sets of DataWriteObjects representing contiguous areas of the file. When the DataWriteQueue 2101 receives multiple DataWriteObjects representing a contiguous area of the file, the DataWriteQueue 2101 collects the DataWriteObjects into a single chain internally, regardless of which connection each DataWriteObject comes from. The DataWriteQueue thus stores DataWriteObjects as an unordered set of DataWriteObject chains.

When the writer thread 2102 of FIG. 21 removes DataWriteObjects from the DataWriteQueue, the writer thread 2102 indicates the current file position. To possibly avoid a file seek operation, the DataWriteQueue 2101 provides a DataWriteObject whose offset is the current file position 2104. The writer thread 2102 may then write to the current file position 2104 without performing a seek operation. Internally, the DataWriteQueue 2101 maintains a collection of M DataWriteObject chains, representing contiguous areas of the file. The DataWriteQueue 2101 checks the beginning offsets of the M DataWriteObject chains, and if there is a chain whose initial offset matches the current file position, then the entire chain is returned.

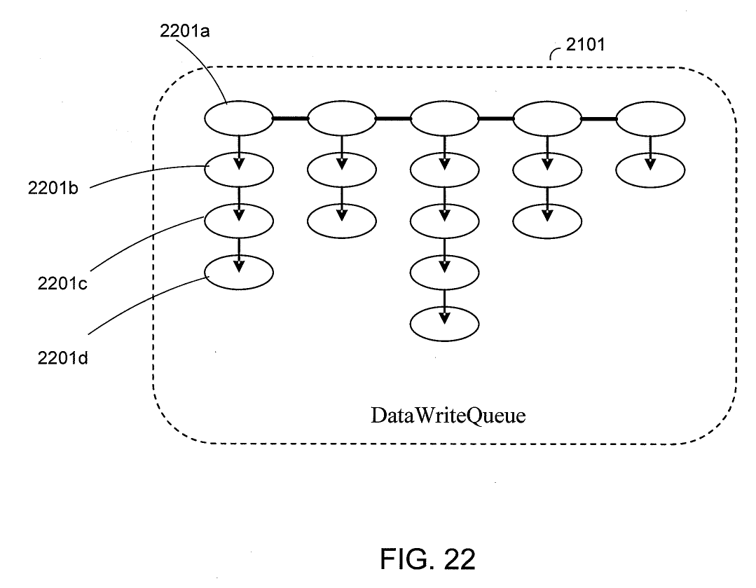

FIG. 23 is another representative view of a writing operation in an I/O storage system of the recipient 102 of FIG. 1. Generally, the multiple connections may write the data to an in-memory buffer to reassemble the data because the data may not come in sequence. By measuring I/O storage system write rates while writing the data to disk, it can be determined if the disk is busy processing requests from other applications and tasks. Accordingly, the number of connections can be reduced or increased appropriately, which will be described in greater detail in connection with FIG. 40.

As shown in FIG. 23, the writer thread 2102 writes data to the file in the storage medium 609 (as shown in FIG. 6). The use of the writer thread 2102 decouples the N reader threads from the file write operations. DataWriteObjects are added by the connections 605a to 605c, and are removed by the writer thread 2102. The rate at which the writer thread 2102 writes data to the storage medium 609 is the measured write rate for the I/O storage system.

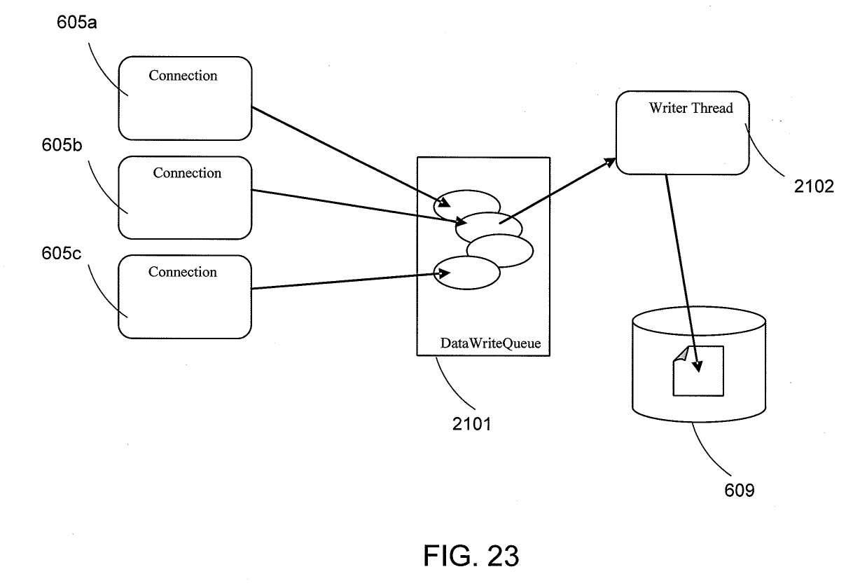

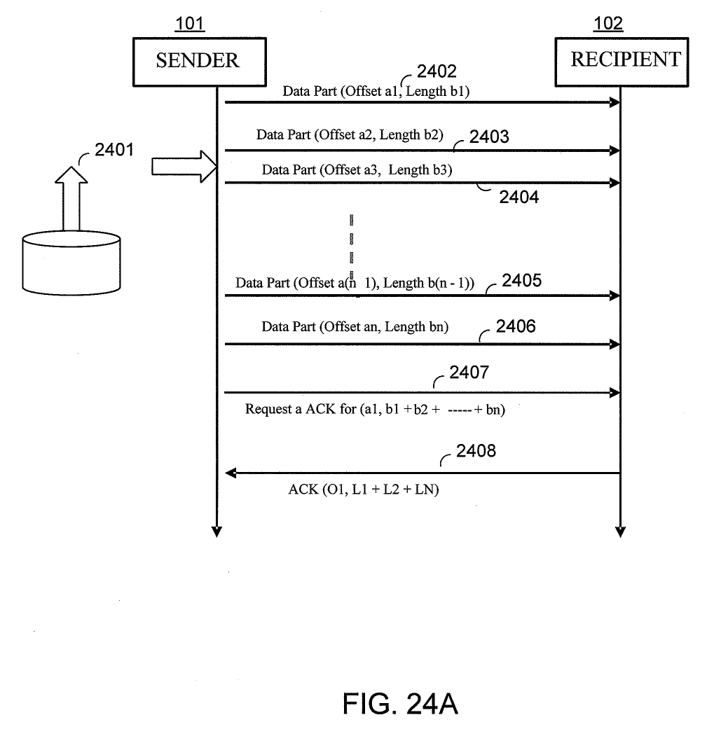

FIG. 24A is a sequence diagram for detecting a bottleneck in data transfer in an I/O storage system of the sender 101 in FIG. 1. Generally, the sender 101 may utilize a round-trip time (RTT) to find network performance. The RTT utilized might be TCP's RTT or any other proprietary approach to calculate a RTT. Modern TCP implementations seek to answer the question of network performance by monitoring the normal exchange of data packets and developing an estimate of how long is “too long”. This process is called round trip time (RTT) estimation. RTT estimates are an important performance parameter in a TCP exchange, especially in an indefinitely large transfer, in which most TCP implementations eventually drop packets and retransmit them, regardless of the good quality of the link. If the RTT estimate is too low, packets are retransmitted unnecessarily; if the RTT estimate is too high, the connection can sit idle while the host waits to timeout. When the sender 101 finds that the RTT time of message packages sent to the recipient 102 is taking longer than the previous message packages, it may indicate that the network is busy and has more traffic. In this case, the sender 101 can reduce the number of connections and inform the recipient 102. Alternatively, when the RTT is taking a shorter period of time, the sender may ask to increase the number of connections. The foregoing reducing and increasing of a number of connections will be described in greater detail in connection with FIG. 40.

In FIG. 24A, the sender 101 can ask the recipient 102 to send an acknowledgment to the sender 101. When the sender 101 detects a situation that it will not hold cached information anymore, the sender 101 will notify the recipient 102 and force the recipient to send an acknowledgment (ACK) to allow both sides to properly clean up cached information and advance to new data parts. In this situation, the recipient can decide if it can increase a number of connections for the sender 101 to utilize more bandwidth. The acknowledgment (ACK) is referring to the acknowledgment on the application layer not the ACK signal in the transport layer (such as TCP protocol). For this, the MDT implements the communicate channel for recipient to inform client that data has arrived as acknowledgment (i.e., the ACK here). Alternatively, a receiver negative acknowledge (RNA) can be utilized to achieve the foregoing described cleaning up of caches.

In particular, in FIG. 24A, the sender 101 reads data into a memory buffer before sending out a message (step 2401). In steps 2402 to 2406, the sender 101 sends a data part with offset a1, length b1, sends a data part with offset a2, length b2, sends a data part with offset a3, length b3, and continues to send data parts until the data parts reach an offset of a(n−1), length b(n−1), and finally an offset of an, length bn, where “n” represents a number of data parts in a sequence. In step 2407, the sender 101 requests that the recipient sends an ACK which includes a list of recognized data parts. The recipient 102 advances the offset and length of values of data packets it has tracked, and writes the data packets to storage. In step 2408, the recipient 102 sends the requested ACK, and the sender 101 cleans up the data cached in the memory buffer.

FIG. 24B is a representative view of a reading operation in an I/O storage system of the sender 101 in FIG. 1. In FIG. 24B, the data buffer reader 2411 reads, in a separate thread, data blocks from the storage medium (i.e., disk) 601. The data buffer reader 2411 uses a double queue mechanism including a “Free” section and a “Full” section. The data buffer reader 2411 loads data buffer parts into the “Full” side of a memory buffer 2412. The data buffer reader 2411 manages the loaded and recycled data buffer parts lists, and provides access to the loaded data buffer parts in a synchronized fashion. In addition, the data buffer parts provide a capability to read and write their contents to and from the network.

DataBlobSerializerPartStream 2421a, 2421b and 2421c retrieve loaded data parts from the data buffer reader 2411 and send the data parts sequentially over the network. DataBlobSerializerPartStream extends DataBlobSerializer for a given input stream or data buffer reader to serialize the data with PDP protocol connection based data. The DataBlobSerializerPartStream 2421a, 2421b and 2421c also recycle the utilized data parts. Connections 604a, 604b and 604c provide an end-to-end connection socket with the remote host, and use the DataBlobSerializerPartStream objects 2421a, 2421b and 2421c to send data to the remote host. The connections 604a, 604b and 604c work in parallel with other connection instances on the local host.

The sophisticated double queue mechanism shown in FIG. 24B provides the following efficiency concepts: (1) asynchronous reading of data from the disk, thus achieving timing overlaps in data reading and data sending, (2) ability to provide synchronous access to the list of loaded data buffer parts which allows simultaneously running connection threads to send the data in parallel over multiple sockets, and (3) ability to reuse data buffer parts, thus substantially avoiding unnecessary heap memory allocation and garbage collection.

When the data buffer reader 2411 reads data from the storage medium (i.e., disk) 601 faster than the network can send the data, and the memory buffer reaches its limitation (which applies to many client-server application systems), the client will stop reading data into the memory buffer until memory is available. This results in time spans where the reading of data from the disk and sending of the data on the network does not overlap, resulting in an un-normalized flow of data across the system. This reduces the net throughput of data for at least larger data sets. However, once it is detected that the sender's memory buffer is getting full frequently, which identifies the network being a bottleneck to the transfer of data, a corrective action can be taken by reducing the number of connections so as to reduce clogging of the network with data when the bandwidth is low. and at the substantially the same time, introducing Delays are also introduced in reading of data from the storage medium (i.e., disk) at substantially the same time as the number of connections is reduced, to achieve a fairly normalized flow of sending data. The foregoing described detection and corrective action will be described in more detail below in connection with FIG. 40.

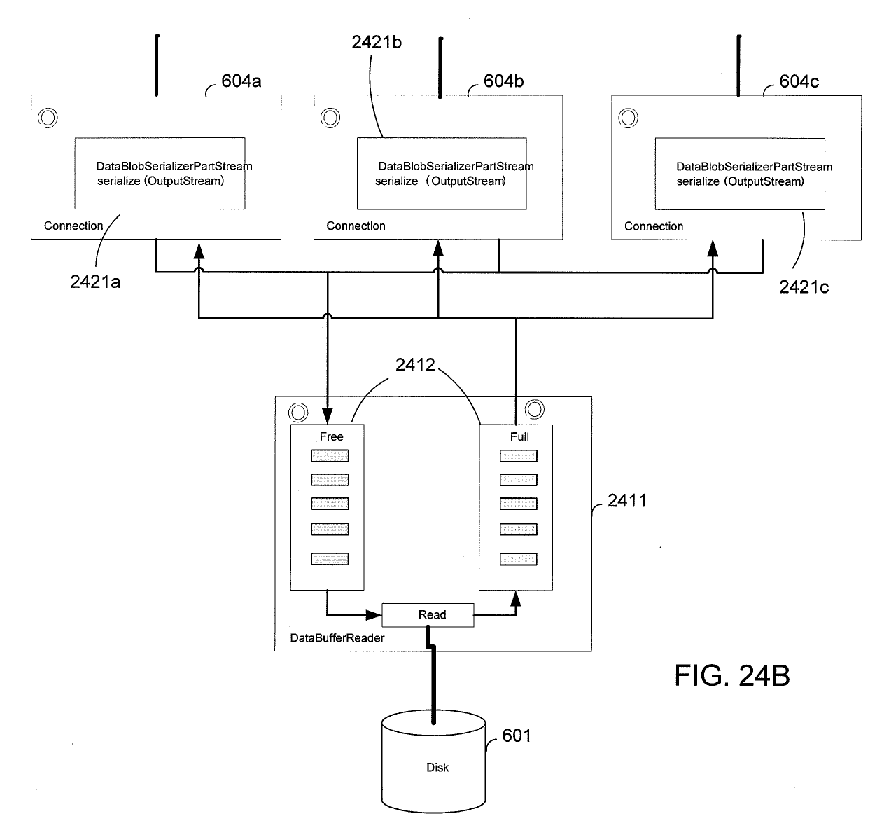

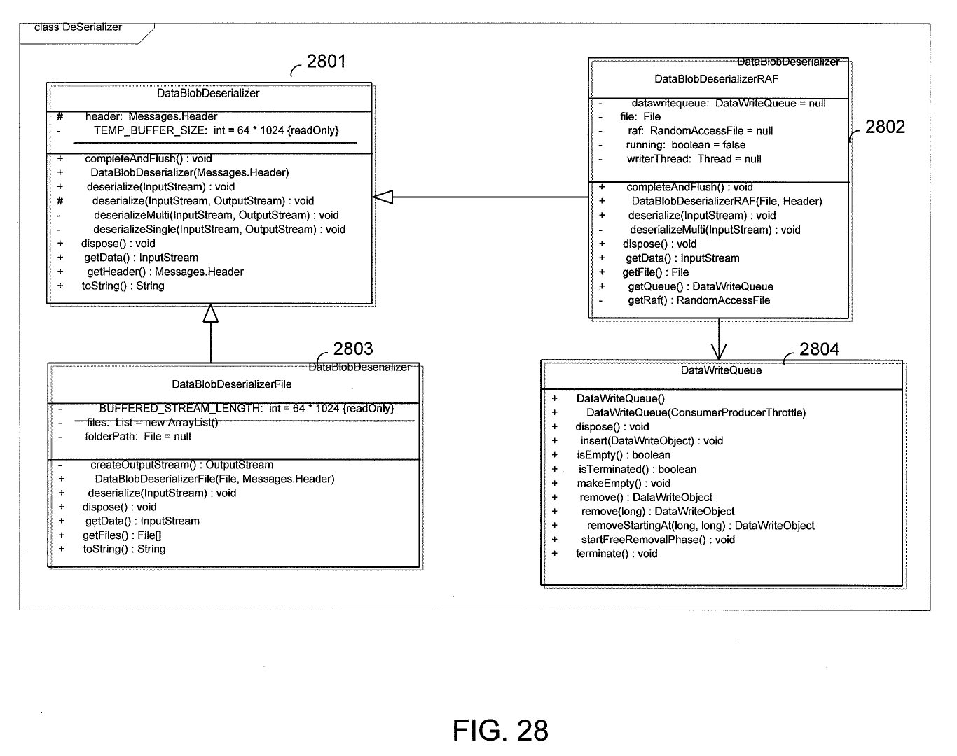

FIGS. 25 to 28 are class diagrams for each of major classes that form a core of an architecture of an example embodiment. A description with respect to the particular relationships and interaction between each of the major classes is provided in detail below in connection with FIGS. 29 to 39.

FIG. 25 is a class diagram for a server according to an example embodiment. As shown in FIG. 25, a server::ServerSession object 2501 associates with a server::Dispatcher object 2502, a server::ServerConnection object 2503, and a server::Server object 2504. In addition, the server::ServerConnection object 2503 associates with the server::ServerSession object 2501 and the server::Server object 2504. Moreover, the server::Server object 2504 associates with the server::ServerSession object 2501 and the server::Dispatcher object 2502. It should be noted that the classes specified in this diagram are used by MDT application to create PDP protocol server to accept PDP protocol client connect request and maintain server session via the SOAP Connection Library (i.e., SCL). The Server object implements the PDP server, creates and starts an instance of the PDP server to listen to the specific address and port, and builds and maintains a server connection section and join session. The caller can retrieve a session id from this class as well.

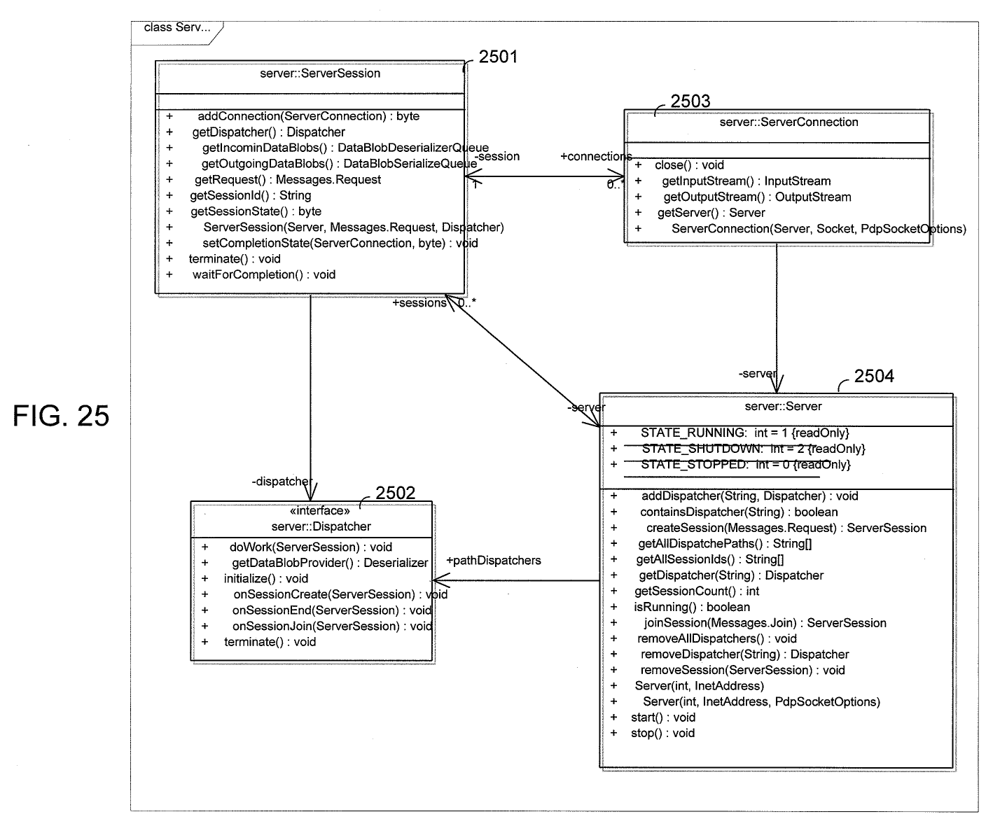

FIG. 26 is a class diagram for a client according to an example embodiment. As shown in FIG. 26, each of a ClientConnection object 2603 and a SimpleClient object 2602 associate with a ClientSession object 2601. These classes are used by MDT application to create PDP protocol to connect to PDP protocol server connection and maintain client session via Soap Connection library.

FIG. 27 is a class diagram for a data serializer according to an example embodiment. As shown in FIG. 27, a DataBlobItem object 2703 associates with a DataBlobSerializer object 2701. In addition, each of a DataBlobSerializerPartStream object 2702 and a DataBlobSerializerNoData object 2704 associate with the DataBlobSerializer object 2701. Both the DataBlobSerializerNoData and the DataBlobSerializerPartStream extend the DataBlobSerializer object. Also, DataBlobSerializerNoData provides a data-blob serialized that does not contain any data.

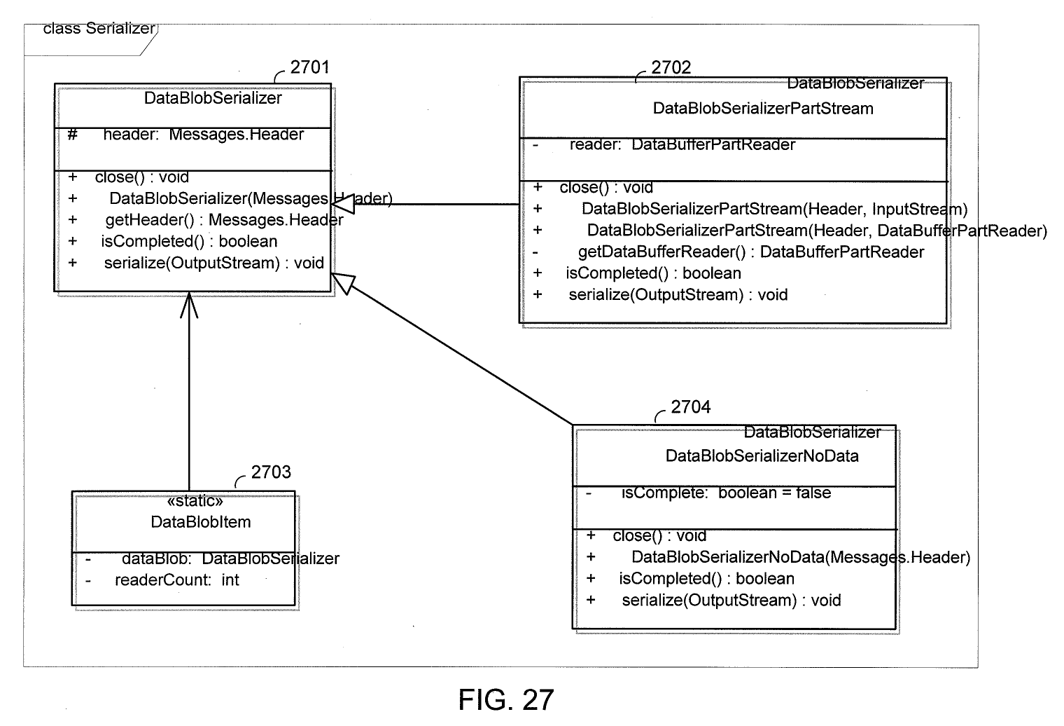

FIG. 28 is a class diagram for a data deserializer according to an example embodiment. As shown in FIG. 28, each of a DataBlobDeserializerFile object 2803 and a DataBlobDeserializerRAF object 2802 inherits a DataBlobDeserializer object 2801. In addition, the DataBlobDeserializerRAF object 2802 associates with a DataWriteQueue object 2804. The DataBlobDeserializer defines a data-blob deserializer and DataBlobDeserializerFile, DataBlobDeserializerRAF, DataBlobSerializerQueue extends this object and utilizes SCL MessageSerializer object to deserialize a message in a MessageContext object.

FIG. 29 is a sequence diagram for establishing a session at a client. As shown in FIG. 29, in 2901, a client::ClientSession object inherits a startSession( ) from a Developer. In 2902, an <<interface>>:PdpClientSocketFactory object inherits a create(UrlEx):Socket from the client::ClientSession object. In 2903, a <<static>>:Request object inherits a write(OutputStream) from a :ClientConnection object. In 2904, a <<static>>:Response object inherits a read(InputStream) from the :ClientConnection object. In 2905, the :ClientConnection object inherits a getResponse( ) :Messages.Response from the client::ClientSession object. Message.Response is an internal class of Message class (not shown), and defines the PDP response message. The Message class contains all transport messages used for PDP communication. With this class, the caller can get the next PDP message from the input stream, and defines the base PDP message.

In 2906, the client::ClientSession object inherits a joinSession( ) from the Developer. In 2907, the <<interface>>:PdpClientSocketFactory object inherits a create(UrlEx):Socket from the client::ClientSession object. In 2908, a <<static>>:Join object receives a write(OutputStream) from a :ClientConnection object. In 2909, a <<static>>:Response object inherits a read(InputStream) from the :ClientConnection object. In 2910, the :ClientConnection object inherits a getResponse( ) :Message.Response from the client::ClientSession object. In 2911, the client::ClientSession object inherits a waitForCompletion( ) from the Developer. In 2912, the :ClientConnection inherits a doRequest( ) from itself. In 2913, the :ClientConnection associates associates a setCompletionState(REQUEST) with the client::ClientSession.

In 2914, the :ClientConnection object inherits a doRequest from itself. In 2915, the :ClientConnection associates a setCompletionState(REQUEST) with the client::ClientSession. In 2916, the :ClientConnection inherits a doResponse( ) from itself. In 2917, the :ClientConnection object associates a setCompletionState(RESPONSE) with the client::ClientSession object. In 2918, the :ClientConnection object inherits a doResponse( ) from itself. In 2919, the :ClientConnection object associates a setCompletionState(RESPONSE). In 2920, the :ClientConnection object inherits a close( ) from itself. In 2921, the :ClientConnection object inherits a close( ) from itself.

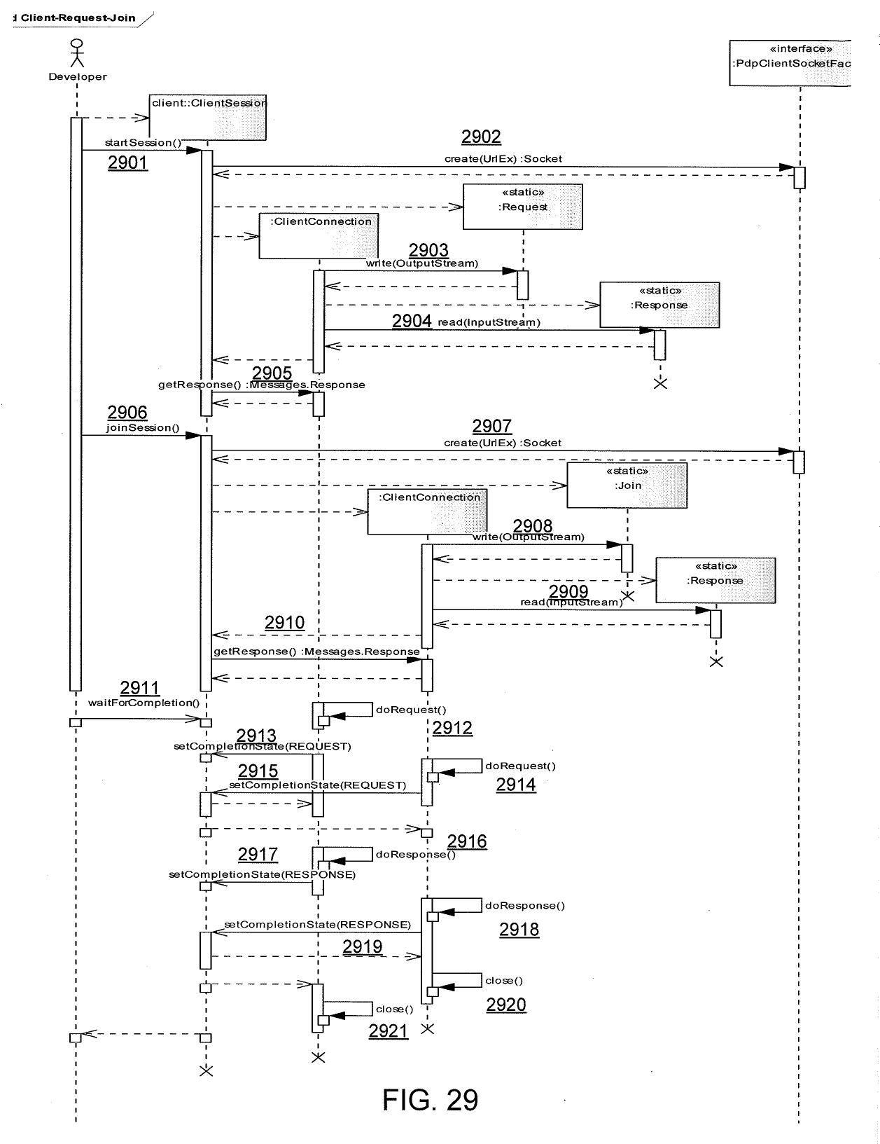

FIG. 30 is a flow chart for providing a description of establishing a start session at a sender, for example sender 101 of FIG. 1, according to an example embodiment. In step 3001, establishment of the start session begins. In step 3002, a socket is created at the sender for establishing the start session. In step 3003, a request message is sent by the sender to a recipient, for example, recipient 102 of FIG. 1, to establish the start session. The sender then reads a response message sent to the sender from the recipient (step 3004). In step 3005, it is determined whether the response message indicates that the sent request message for establishing a start session was successful. If the request was not successful, then the socket created in step 3002 is closed (step 3006). If the request was successful, then the session is created (step 3007), and a further request is performed (step 3008).

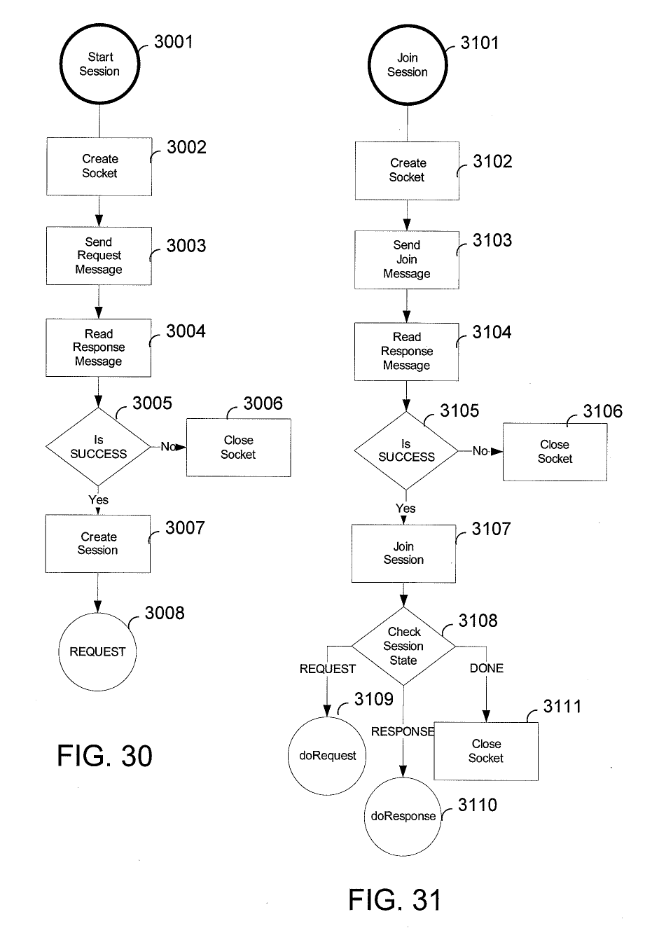

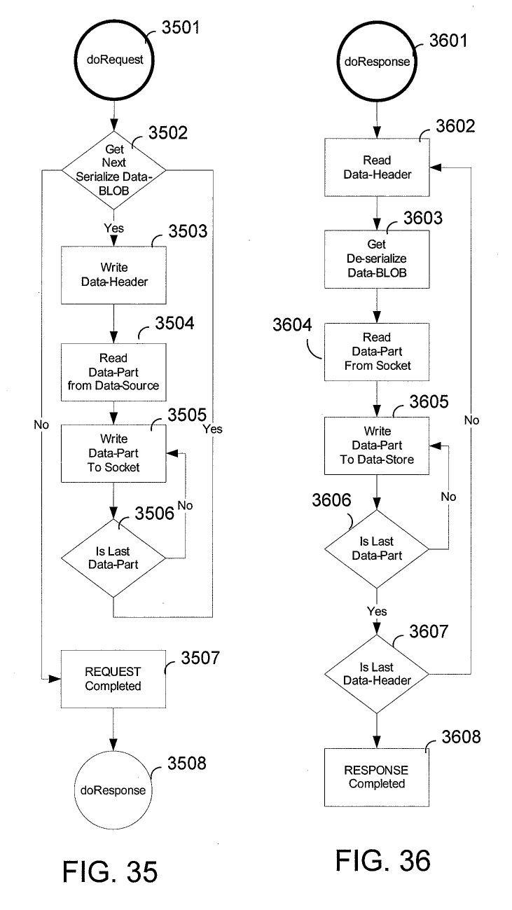

FIG. 31 is a flow chart for providing a description of establishing a join session at a sender, for example sender 101 of FIG. 1, according to an example embodiment. In step 3101, establishment of a join session begins. In step 3102, a socket is created at the sender for establishing the join session. In step 3103, a join message is sent by the sender to a recipient, for example, recipient 102 of FIG. 1, to establish a join session. The sender then reads a response message sent to the sender from the recipient (step 3104). In step 3105, it is determined whether the response message indicates that the sent join message for establishing a join session was successful. If the join message was not successful, then the socket created in step 3102 is closed. If the join message was successful, then the join session is created (step 3107). In step 3108, a check is made of the session state. If the session is done, then the socket is closed (step 3111). If a further request is warranted, then the process proceeds to step 3109, which is described in detail in connection with FIG. 35. If the a further response is warranted, then the process proceeds to step 3110 which is described in detail in connection with FIG. 36.

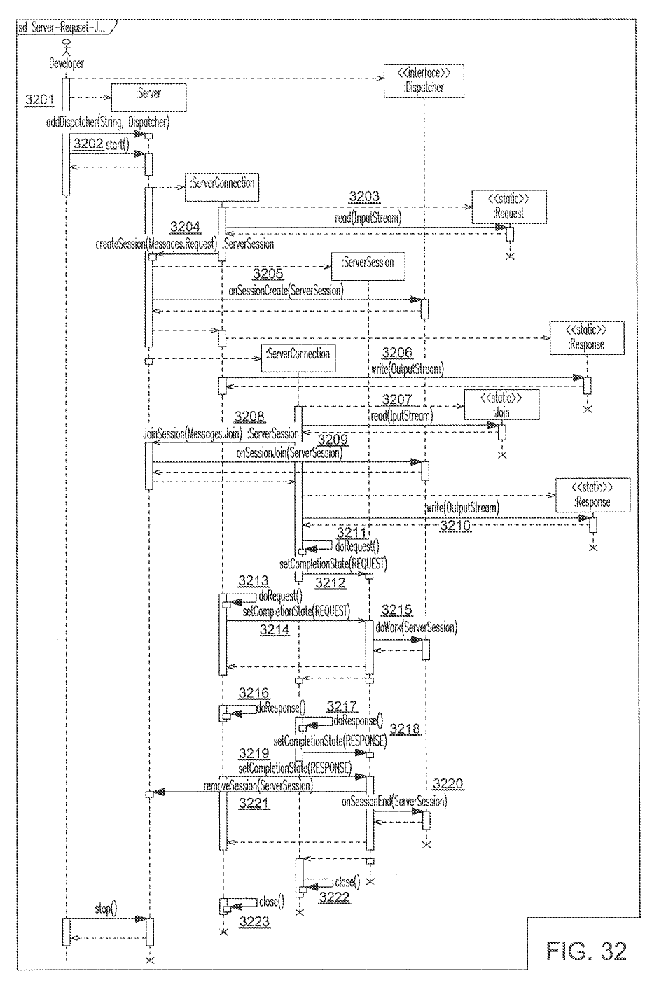

FIG. 32 is a sequence diagram for establishing a session at a server. As shown in FIG. 32, in 3201, a :Server object inherits an addDispatcher(String, Dispatcher) from a Developer. In 3202, the :Server object inherits a start( ) from the Developer. In 3203, a <<static>>:Request object inherits a read(InputStream) from a :ServerConnection object. In 3204, the :ServerConnection object associates a createSession(Messages.Request) :ServerSession with the :Server object. It should be noted that the Message.Request passed as a parameter here is an internal class of Messages class (not shown), and it defines the PDP request message.

In 3205, a <<interface>>:Dispatcher inherits an on SessionCreate(ServerSession) from the :Server object. In 3206, the <<static>>:Response inherits a write(OutputStream) from the :ServerConnection object. In 3207, a <<static>>:Join object inherits a read(InputStream) from the :ServerConnection object. In 3208, the :ServerConnection object associates a joinSession(Messafees.Join):ServerSession with the :Server object. In 3209, the <<interface>>:Dispatcher object inherits an on SessionJoin(ServerSession) from the :Server object. In 3210, a <<static>>:Response object inherits a write(OutputStream) from the :ServerConnection object.

In 3211, the :ServerConnection object inherits a doRequest( ) from itself. In 3212, the :ServerConnection associates a setCompletionState(REQUEST) with the :ServerSession object. In 3213, a :ServerConnection inherits a doRequest( ) from itself. In 3214, the :ServerConnection object associates a setCompletionState(REQUEST) with the :ServerSession object. In 3215, a <<interface>>:Dispatcher object inherits a doWork(ServerSession) from the :ServerSession object. In 3216, the :ServerConnection object inherits a doResponse( ) from itself. In 3217, the :ServerConnection object inherits a doResponse( ) from itself. In 3218, the :ServerSession object inherits a setCompletionState(RESPONSE) from the :ServerConnection object. In 3219, the :ServerSession object inherits a setCompletionState(RESPONSE) from the :ServerConnection object. In 3220, the <<interface>>:Dispatcher object inherits an on SessionEnd(ServerSession) from the :ServerSession object. In 3221, the :Server object inherits a removeSession(ServerSession) from the :ServerSession object. In 3222 and 3223, the :ServerConnection objects inherits a close( ) from themselves.

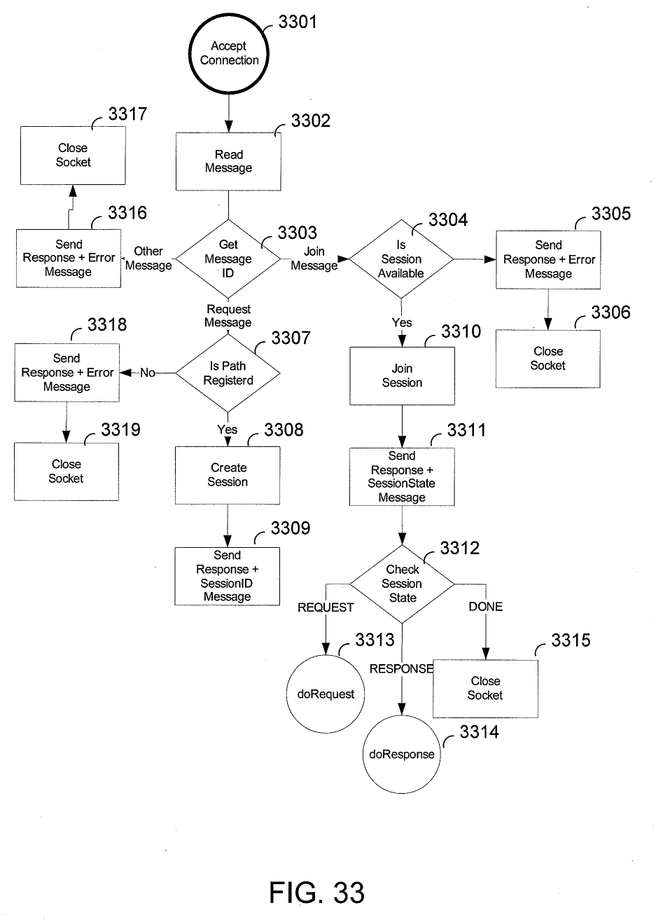

FIG. 33 is a flow chart for providing a description of establishing a session at the recipient according to an example embodiment. In step 3301 of FIG. 33, acceptance of a connection begins. In step 3302, a message sent by a sender is received by the recipient, and the recipient reads the message. In step 3303, an ID of the message is obtained. If the ID of the message indicates that the message is other than a request message or a join message, then the recipient sends a response to the sender, together with an error message (step 3316), and closes the utilized socket (step 3317). If the message is a request message, then it is determined whether the requested connection path is registered (3307). If the path is not registered, then the recipient sends a response to the sender, together with an error message (step 3318), and closes the utilized socket (step 3319). If the path is registered, then a session is created (step 3308), and a response is sent, together with a session ID Message, from the recipient to the sender (step 3309).

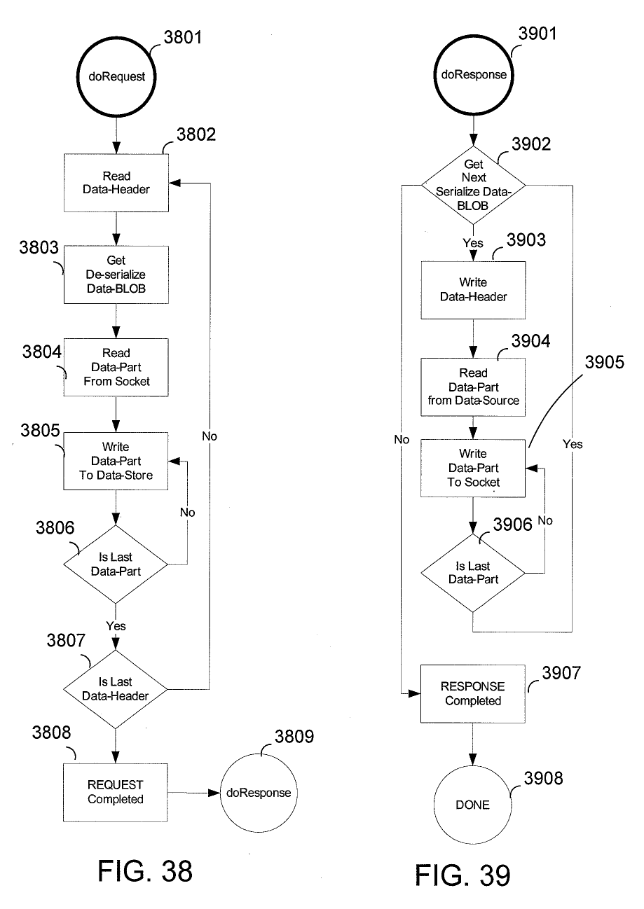

In step 3303, if the message is a join message, then the recipient determines whether the requested join session is available (step 3304). If the session is not available, then the recipient sends a response to the sender, together with an error message (step 3305), and closes the utilized socket (step 3306). If the session is available, then the session is joined (step 3310), and a response is sent, together with a session state message, from the recipient to the sender (step 3311). In step 3312, a check is made of the session state. If the session is done, then socket is closed (step 3315). If a further request is warranted, then the process proceeds to step 3313, which is described in detail in connection with FIG. 38. If a further response is warranted, then the process proceeds to step 3314 which is described in detail in connection with FIG. 39.

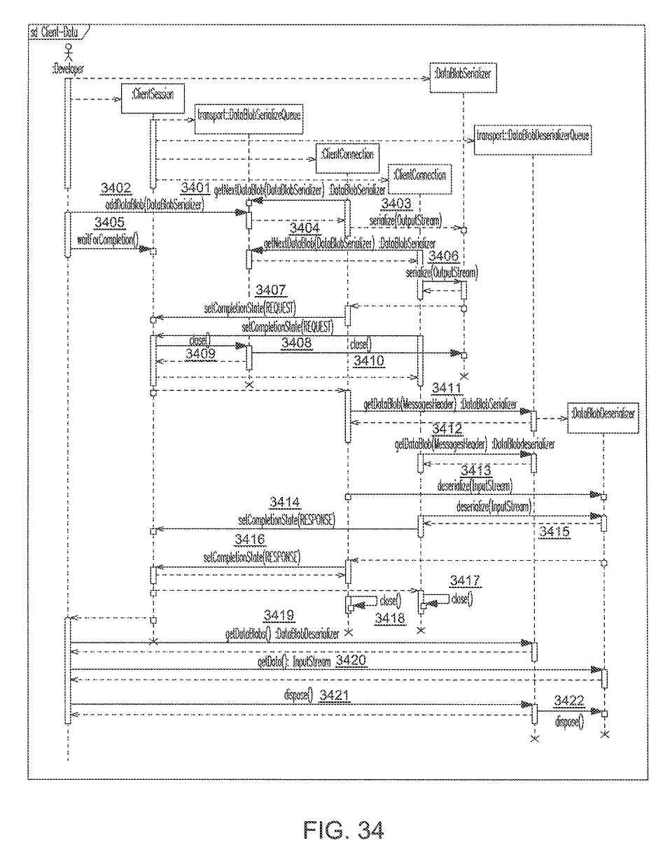

FIG. 34 is a sequence diagram for data exchange at a client. As shown in FIG. 34, in 3401, a transport::DataBlobSerializeQueue object inherits a getNextDataBlob(DataBlobSerializer):DataBlobSerializer from a :ClientConnection object. In 3402, the transport::DataBlobSerializeQueue object inherits an addDataBlob(DataBlobSerializer) from a Developer. In 3403, the :ClientConnection object associates a serialize(OutputStream) with a :DataBlobSerializer object. In 3404, the transport::DataBlobSerializeQueue object inherits a getNextDataBlob(DataBlobSerializer):DataBlobSerializer from a :ClientConnection object. In 3405, a :ClientSession object inherits a waitForCompletion( ) from the Developer. In 3406, the :ClientConnection associates a serialize(OutputStream) with the :DataBlobSerializer object. In 3407, the :ClientConnection object associates a setCompletionState(REQUEST) with the :ClientSession object. In 3408, the :ClientConnection object associates a setCompletionState(REQUEST) with the :ClientSession object.

In 3409, the transport::DataBlobSerializerQueue inherits a close( ) from the :ClientSession object. In 3410, the :DataBlobSerializer object inherits a close( ) from the transport::DataBlobSerializerQueue object. In 3411, a transport::DataBlobDeserializerQueue inherits a getDataBlob(Messages.Header) :DataBlobDeserializer from the :ClientConnecion object. In 3412, the transport::DataBlobDeserializerQueue object inherits a getDataBlob(Messages.Header) :DataBlobDeserializer from the :ClientConnection object. It should be noted that the Message.Header is an internal class of Messages class (not shown), and it defines the DATA-HEADER message. In 3413 and 3415, a :DataBlobDeserializer object inherits a deserializer(InputStream) and a deserializer(InputStream) from the :ClientConnection objects. In 3414 and 3416, the :ClientConnection objects associates a setCompletionState(RESPONSE) with the :ClientSession object. In 3417 and 3418, the :ClientConnection objects inherit close( ) from themselves. In 3419 and 3421, the transport::DataBlobDeserializerQueue object inherits a getDataBlobs( ) :DataBlobDeserializer and a dispose( ) from the Developer. In 3420 and 3422, the :DataBlobDeserializer object inherits a getData( ):InputStream and a dispose( ).

FIGS. 35 and 36 are flow charts for providing a general description for data exchange at the sender. In step 3501 of FIG. 35, a request to send data begins. In step 3502, the sender determines if there is a next available serialized data-blob to get. If there is a next available data-blob, then the sender writes a data-header for the data-blob (step 3503), reads a data part of the data-blob from a source of the data (step 3504), and writes the read data part to a created socket (step 3505). In step 3506, the sender determines whether the data part is a last data part of the data blob. If the data part is not the last data part, then the sender writes a next data part of the data blob to the created socket (step 3505). If the data part is the last data part in step 3506, then the process goes back to step 3502. If in step 3502 it is determined that there is not a next available serialized data-blob, then the request is completed (step 3507), and a response to data received is performed (step 3508).

In FIG. 36, in step 3601, the response to data received is performed. In step 3602, a data-header for incoming data is read. In step 3603, the sender obtains a de-serialized data-blob associated with the read data-header. In step 3604, the sender reads a data part of the data-blob from a created socket. In step 3605, the sender writes the read data part to a data storage. In step 3606, the sender determines whether the data part is a last data part of the data blob. If the data part is determined to not be the last data part, then the process returns to step 3605 where the sender writes a next data part to the data storage. If the data part is determined to be the last data part, then the process proceeds to step 3607. In step 3607, the sender determines whether the data header is a last data-header for data to be received. If the data-header is the last data-header, then the response is completed (step 3608).

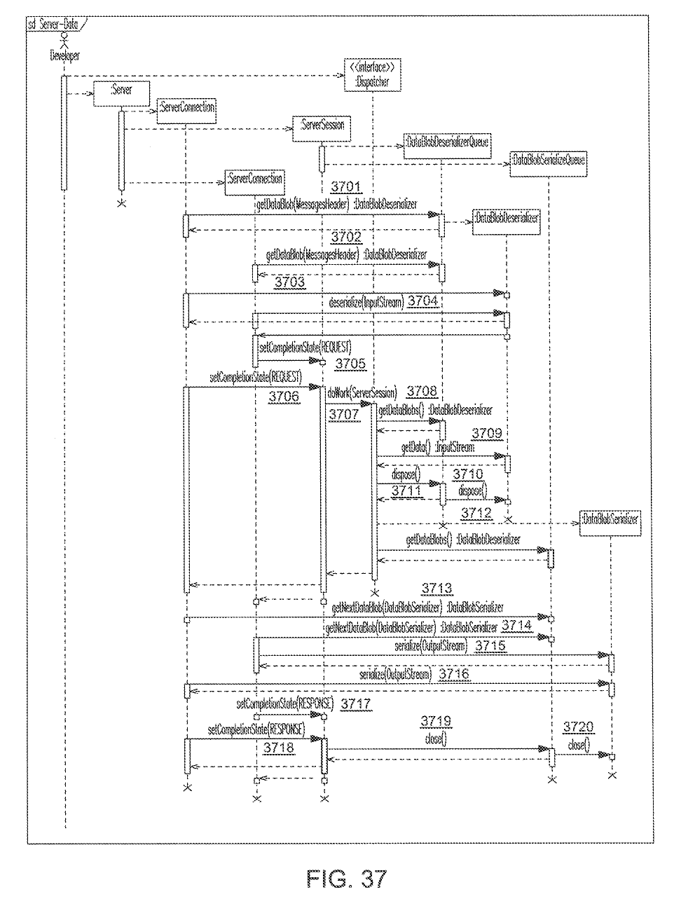

FIG. 37 is a sequence diagram for data exchange at a server. As shown in FIG. 37, in 3701 and 3702, a :DataBlobDeserializerQueue object inherits a getDataBlob(Messages.Header):DataBlobDeserializer from a ServerConnection object. In 3703 and 3704, a :DataBlobDeserializer object inherits a deserializer(InputStream) from the :ServerConnection object. In 3705 and 3706, a :ServerSession object inherits a setCompletionState(REQUEST) from the :ServerConnection object. In 3707, an <<interface>>:Dispatcher object inherits a doWork(ServerSession) from the :ServerSession object. In 3708, a :DataBlobDeserializerQueue inherits a getDataBlobs( ) :DataBlobDeserializer from the <<interface>>:Dispatcher object. In 3708, the :DataBlobDeserializerQueue inherits a getDataBlobs( ):DataBlobDeserializer from the <<interface>>:Dispatcher object. In 3709, the :DataBlobDeserializer object inherits a getData( ):InputStream from the <<interface>>:Dispatcher object.

In 3710 and 3711, the :DataBlobDeserializerQueue object and the :DataBlobDeserializer object inherit dispose( ) In 3712, the :DataBlobSerializerQueue object inherits an addDataBlob(DataBlobSerializer) from the <<interface>>:Dispatcher object. In 3713 and 3714, the :DataBlobSerializerQueue object inherits a getNextDataBlob(DataBlobSerializer):DataBlobSerializer from the :ServerConnection objects. In 3715 and 3716, a :DataBlobSerializer object inherits a serialize(OutputStream) from the :ServerConnection objects. In 3717 and 3718, the :ServerSession inherits a setCompletionState(RESPONSE) from the :ServerConnection objects. In 3719 and 3720, the :DataBlobSerializerQueue object and the :DataBlobSerializer object inherit a close( ).

FIGS. 38 and 39 are flow charts for providing a general description for data exchange at the recipient. In FIG. 38, in step 3801, the response to data received is performed. In step 3802, a data-header for incoming data is read. In step 3803, the recipient obtains a de-serialized data-blob associated with the read data-header. In step 3804, the recipient reads a data part of the data-blob from a created socket. In step 3805, the recipient writes the read data part to a data storage. In step 3806, the recipient determines whether the data part is a last data part of the data blob. If the data part is determined to not be the last data part, then the process returns to step 3805 where the recipient writes a next data part to the data storage. If the data part is determined to be the last data part, then the process proceeds to step 3807. In step 3807, the recipient determines whether the data header is a last data-header for data to be received. If the data-header is the last data-header, then the response is completed (step 3808).

In step 3901 of FIG. 39, a request to send data begins. In step 3902, the recipient determines if there is a next available serialized data-blob to obtain. If there is a next available data-blob, then the recipient writes a data-header for the data-blob (step 3903), reads a data part of the data-blob from a source of the data (step 3904), and writes the read data part to a created socket (step 3905). In step 3906, the recipient determines whether the data part is a last data part of the data blob. If the data part is not the last data part, then the recipient writes a next data part of the data blob to the created socket (step 3905). If the data part is the last data part in step 3906, then the process goes back to step 3902. If in step 3902 it is determined that there is not a next available serialized data-blob, then the request is completed (step 3907), and a response to data received is performed (step 3908).

### Autotuning a Number of Connections Between a Sender and a Recipient

FIG. 40 is a flow chart for providing a detailed explanation of another example embodiment. More specifically, FIG. 40 depicts a flowchart for providing a detailed explanation of an example embodiment for mass transfer of data from a sender 101 to a recipient 102 connected to the sender 101 via a network 120 as shown in FIG. 1.

As shown in FIG. 40, in steps 4001 and 4002, plural connections are established between the sender 101 and the recipient 102 via the network 120. These connections can be, for example, parallel TCP connections; however, the plural connections are not limited to TCP connections, and other protocols using parallel connections may be used. In step 4003, data is sent from the sender 101 to the recipient 102 by divided sending of the data over the plural connections so as to aggregate a utilization of a bandwidth of the network 120. In step 4004, the recipient 102 receives the divided data over the plural connections, and the recipient 102 recombines the divided data into its original form.

In steps 4005 to 4010, autotuning is performed based on the number of connections between the sender 101 and the recipient 102, based on at least a performance of an I/O storage system at the sender 101, a performance of an I/O storage system at the recipient 102, and a performance of the network 120. The autotuning is performed to provide an optimal number of connections between the sender and the recipient so as to provide an ideal and efficient throughput of data. More particularly, in step 4005, a determination is made as to whether an I/O storage system of the sender 101 is reading data faster than data is being sent out over the network 120 via the autotuning software 236 shown in FIG. 2. This determination is made, for example, by comparing a calculation of a rate at which the I/O storage system of the sender 101 is inputting data into the sender's memory buffer, and a calculation of a rate at which data is being taken from the sender's memory buffer from the network 120. If in step 4005 it is determined that the I/O storage system of the sender 101 is reading data faster than data is being sent out over the network 120, autotuning is performed on the number of connections between the sender 101 and the recipient 102, in which the sender 101 sends a request to the recipient 102 to open a new connection. If the recipient 102 returns a response that the request to open a new connection was successful, then the sender 101 can send data over the new connection so as to provide a smooth flow of data in the system.

When sending the request to open a new connection, the sender 101 may request that one or more new connections be opened. However, if the sender 101 requests that numerous new connections be opened, the recipient 102 may deny the request to open all of the new connections for a number of different reasons which will be described in greater detail below.

If in step 4005 it is determined that the I/O storage system of the sender 101 is not reading data faster than data is being sent out over the network 120, then the process proceeds to step 4006. In step 4006, a determination is made as to whether the I/O system of the sender 101 is reading data slower than data is being sent out over the network 120. If it is determined that the I/O system of the sender 101 is reading data slower than data is being sent out over the network 120, and more than one sender, for example, one of senders 131 and 132 of FIG. 1, is sending data to the recipient 102, then the sender 101 closes an existing connection of the plural connections to auto-tune the number of connections between the sender 101 and the recipient 102. In this regard, the closing of an existing connection is a closing of a secondary connection, not a primary connection. As a result of the foregoing, the sender 101 may substantially prevent occupation of sockets at the recipient 102 that are not being fully utilized by the sender 101 to send data.

By checking the sender's memory buffer that has low utilization, for example when the memory buffer utilization stays low for a certain period of time (e.g., 30 seconds) and stays under a predefined threshold (e.g., 30%) of total memory buffer size, then the sender can conclude that the sender is reading data slower than data is being sent. Likewise, if memory utilization is high for a period of time and a threshold (such as 80% of the memory buffer is being used) is reached during that timeframe, then the sender can conclude that the I/O system of the sender 101 is reading data faster than data is being sent out over the network 120.

In step 4009, detection is made, by autotuning software 336, as to whether a bottleneck to mass transfer of data exists in an I/O storage system of the recipient 102. If an affirmative detection is made that a bottleneck to mass transfer of data exists in the I/O storage system of the recipient 102, autotuning is performed on the number of connections between the sender 101 and the recipient 102, in which the recipient 102 closes an existing connection (i.e., a secondary connection). The recipient 102 can close one or more existing secondary connections.

In a case that the sender 101 detects that a buffer at the sender 101 is substantially full, the sender 101 may send a request to the recipient to open a new connection, or utilizes a connection that has already been created but is not currently being used to send data. Opening a new connection when a buffer at the sender is substantially full has an advantageous effect of providing a smooth overall data transfer because delays or gaps in sending data from the sender can be reduced. Alternatively, in a case that the sender detects that a bottleneck to mass transfer of data exists in the I/O storage system of the sender, the sender 101 may close an existing secondary connection. An affirmative detection is made of a bottleneck to mass transfer of data in the I/O storage system of the sender 101 when a buffer at the sender 101 is substantially empty.

In some cases, the I/O storage system of the recipient 102 includes a disk, for example, a disk 609 of FIG. 6. In these cases, an affirmative detection is made of a bottleneck to mass transfer of data in the I/O storage system of the recipient 102 when a seek operation of the disk is performed on the I/O storage system of the recipient 102. More specifically, data may not arrive in order at the recipient 102 because plural connections are being used. If the recipient 102 times out or fills its memory buffer waiting for a next consecutive data chunk, the I/O storage system of the recipient 102 may do a disk write for out of order data, which might later require additional seek operations. This may mean that data is being transferred from the sender 101 to the recipient 102 faster than the I/O storage system of the recipient 101 is writing data to the disk. Thus, a bottleneck might exist in the I/O storage system of the recipient 102.

Alternatively, in those cases that the I/O system of the recipient 102 includes a disk, an affirmative detection is made of a bottleneck to mass transfer of data in the I/O storage system of the recipient 102 when the I/O storage system of the recipient 102 is writing data to the disk slower than a previous I/O write rate. The previous I/O write rate can be based on a previously measured I/O write rate for more than one writing operation, or can be based on a previously measured I/O write rate for a time period of write operation, or can be based on a weighted average of previously measured I/O write rates of writing operations. For example, if a previous I/O write rate of the I/O storage system of the recipient is 10 Mb/s, and the I/O storage system of the recipient is currently writing data at 5 Mb/s, then a bottleneck might exist in the I/O storage system of the recipient. The slowing I/O storage system write rate of the recipient may occur when, for example, the I/O storage system is processing other non-MDT applications.

In step 4010, a determination is made as to whether the I/O storage system of the recipient 102 is writing data faster than data is received from the network 120. This determination can be made, for example, by comparing a calculation of the rate at which the I/O storage system of the recipient 102 is writing data from a memory buffer of the recipient 102, and a calculation of the rate at which data is being put into the memory buffer of the recipient 102 by the network 120. If it is determined that the I/O storage system of the recipient 102 is writing data faster than data is received from the network 120, then the recipient 102 instructs or suggests the sender to open a new connection (via the ACK mechanism as shown in FIG. 5).

In step 4010 of FIG. 40, if it is determined that the I/O storage system of the recipient 102 is not writing data faster than data is received from the network 102, then the process proceeds to step 4013. In step 4013, the recipient 102 determines whether all of the data to be sent by the sender 101 has been received by the recipient 102. If all of the data has been received by the recipient 102, then the process ends (step 4014). If all of the data has not been received by the recipient 102, then the process proceeds to step 4004.

In step 4007, the sender 101 detects whether a bottleneck to mass transfer of data exists in the network 120. If in step 4007 an affirmative detection is made that a bottleneck to mass transfer of data exists in the network 120, then the sender 101 closes an existing connection between the sender 101 and the recipient 102. In a case that the bottleneck of mass transfer of data in the network is caused by congestion, further congestion of the network can be reduced by closing an existing secondary connection.

In step 4007, an affirmative detection is made of a bottleneck to mass transfer of data in the network when a current round-trip time (RTT) is longer than a previous RTT. The current RTT and the previous RTT can be based on RTTs for more than one message package, or can be based on a weighted average of RTTs. If the current RTT is substantially longer (e.g., +20%) than the previous RTT, then the network may be busy and have more traffic from other sender-recipient systems. By closing an existing connection when the network is busy, any further congestion caused by sending more data over the busy network may be reduced.

In an example, a sample of weighted measurement may look as follows: if there are 10 RTT sequence samples, such as n0 to n9, then the weighted RTT measurement is as follows: 1^{st}: n0, 2^{nd}: (n0*0.8+n1*0.2), 3^{rd} (2^{nd}*0.8+n2*0.2), 4rd: (3rd*0.8+n3*0.2), . . . 10th: (n9*0.8+n9*0.2).

If in step 4007 a bottleneck to mass transfer of data is not detected in the network 120, then the process proceeds to step 4008. In step 4008, a determination is made as to whether a current round-trip time (RTT) has substantially decreased from a previous RTT. The current RTT and the previous RTT can be based on RTTs for more than one message package, or can be based on a weighted average of RTTs. If in step 4008 it is determined that the current RTT has substantially decreased from a previous RTT, the sender 101 sends a request to the recipient 102 to open a new connection. Decreasing RTTs indicate that the network's performance is improving. Thus, the sender 101 would want to open one or more new connections to increase throughput of data.

In some situations, a buffer size at the sender 101 and the recipient 102 can be adjusted in accordance with a detection of a bottleneck in the network, or in accordance with a detection of a bottleneck in the I/O storage system of the recipient. Specifically in this example embodiment, the size of the buffer at the sender can be increased to possibly prevent the buffer from overflowing with data.

By virtue of the foregoing example embodiment, it is ordinarily possible to provide a self calibration in which a sender and a receiver dynamically increase and decrease the number of connections so as to improve performance for large data transfers by providing an ideal throughput. In addition, fairness is maintained across a large number of sender-receiver arrangements. For example, if the current bottleneck is a system I/O of the recipient, such that the current number of parallel connections has aggregated a surplus of network bandwidth, then some of the connections can be closed, so as to release bandwidth for use by other sender-receiver systems.

In other example embodiments, there are plural senders each sending a respective one of plural mass data transfers to the recipient 102. For example, as shown in FIG. 1, each of senders 131 and 132 may also be sending a mass data transfer to the recipient 102 at substantially the same time as the sender 101 is sending a mass data transfer to the recipient 102. In these example embodiments, when establishing plural connections between the sender 101 and the recipient 102 via the network 120, the recipient 102 sets a maximum number of connections that can be established between the sender 101 and the recipient 102 based on the number of requested connections from the other senders, for example, senders 131 and 132. For example, if the recipient 102 has a maximum of 20 connections that all of the senders can share, and other senders are currently utilizing 15 of the 20 connections, then the recipient 102 may set a maximum of 5 connections on which the sender 101 may use to transfer data based on the 15 connections being used by the other senders.

In some instances, when establishing plural connections between the sender 101 and the recipient 102 via the network 120, the recipient 102 sets a time period for which the maximum number of connections can be established based on the number of requested connections from the other senders. In addition, the recipient 102 may set a starting time for establishing each connection of the maximum number of connections that can be established based on the number of requested connections from the other senders. For example, if a maximum of 3 connections is set by the recipient 102, a first secondary connection may be established one minute after a primary connection is established and the first secondary connection may last for 4 minutes, and a second secondary connection may be established two minutes after the primary connection is established and the second secondary connection may last for 2 minutes.

In some situations, a job queue is maintained by a schedule manager included in the recipient 102 (i.e., the schedule manager 338 in FIG. 3), which governs the number of current connections existing between all of the plural senders, as compared to an incoming number of requested connections. In addition, the schedule manager assigns a priority to each of the plural senders. In this regard, the schedule manager assigns a larger number of connections to a higher priority sender as compared to a lower number of connections to a lower priority sender. For example, a higher priority sender may be a sender having a large data set, compared with a lower priority sender having a smaller data set. In this example, the higher priority sender having the larger data set would be assigned a larger number of connections than the lower priority sender having a smaller data set.

In addition, the sender may send a request to the recipient to open one or more connections when an I/O storage system of the sender is reading data faster than data is being sent out over the network. When autotuning the number of connections, the recipient opens the requested one or more connections if the one or more connections are determined available by the schedule manager.

Moreover, the sender may send a request to the recipient to open one or more connections when a current round-trip time (RTT) has substantially decreased from a previous RTT. The current RTT and the previous RTT can be based on RTTs for more than one message package, or can be based on a weighted average of RTTs. When autotuning the number of connections, the recipient opens the requested one or more connections if one or more connections are determined available by the schedule manager.

In this regard, the connections are opened and closed for a period of time set by the schedule manager. The period of time set by the schedule manager may be a different period of time for each of the different connections. Lastly, each of the connections may be opened at a different starting time.

When multiple requests are received by the recipient 102 from different senders, each sender could send data with different transfer rates constrained by its processing power. The schedule manager 338 can, based on the number of senders and data rates it receives along with the file data size (this value may be available ahead of time), maintain fairness and improve an overall system throughput.

If a new request is received during the process of an existing data transfer request, the recipient 102 can accept the later request and return the number of advised connections that could join the session (along with session-id) for the 2^{nd} request. If the recipient is in the middle of processing and writing data to the I/O storage system, the recipient may return the number of advised connections along with a time to wait value upon expiration of which the join session requests would be honored. Meanwhile, the recipient can reduce the number of connections for the first request and increase the number of allowed connections for the second request, if the recipient knows the amount of data left in the first request is significantly smaller than the amount of data to transfer in the second request. Also, the recipient 102 can reduce the number of connections for the second request and increase the number of allowed connections for the first request, if the recipient knows the amount of data left in the second request is significantly smaller than the amount of data to transfer in the first request.

The schedule manager 338 can also enforce priority on request (i.e., a new request with higher priority arrives during processing of another request). This can be done on the message-level and tied with application policy, or at transport data-level and tied with data to be sent.

This disclosure has provided a detailed description with respect to particular illustrative embodiments. It is understood that the scope of the appended claims is not limited to the above-described embodiments and that various changes and modifications may be made by those skilled in the relevant art without departing from the scope of the claims.

What is claimed is:

1. A method for mass transfer of data from a sender to a recipient connected to the sender via a network, the method comprising:
establishing plural connections between the sender and the recipient via the network;
sending data from the sender to the recipient by divided sending of the data over the plural connections so as to aggregate a utilization of a bandwidth of the network; and
autotuning the optimal number of connections between the sender and the recipient by closing an existing connection when a detection is made that a bottleneck to mass transfer of data exists in an I/O storage system of the recipient, and by opening a new connection when the I/O storage system of the recipient is writing data faster than data is received from the network.

2. A method according to claim 1, wherein the I/O storage system includes a disk, and wherein when autotuning the number of connections, an affirmative detection is made of a bottleneck to mass transfer of data in the I/O storage system of the recipient when a seek operation of the disk is performed on the I/O storage system of the recipient.

3. A method according to claim 1, wherein the I/O storage system includes a disk, and wherein when autotuning the number of connections, an affirmative detection is made of a bottleneck to mass transfer of data in the I/O storage system of the recipient when the I/O storage system of the recipient is writing data to the disk slower than a previous I/O write rate.

4. A method according to claim 1, wherein autotuning further comprises closing by the sender of an existing connection between the sender and the recipient in a case that the sender detects that a bottleneck to mass transfer of data exists in the network, so as to reduce further congestion of the network.

5. A method according to claim 4, wherein an affirmative detection is made of a bottleneck to mass transfer of data in the network when a current round-trip time (RTT) is longer than a previous RTT.

6. A method according to claim 4, further comprising adjusting a buffer size at the sender and the recipient in accordance with a detection of a bottleneck in the network, or in accordance with a detection of a bottleneck in the I/O storage system of the recipient.

7. A method according to claim 1, wherein in a case that the sender detects that a buffer at the sender is substantially full, the sender sends a request to the recipient to open a new connection, or utilizes a connection that has already been created but is not currently being used to send data.

8. A method according to claim 1, wherein there are plural senders each sending a respective one of plural mass data transfers to the recipient.

9. A method according to claim 8, wherein when establishing plural connections between the sender and the recipient via the network, the recipient sets a maximum number of connections that can be established between the sender and the recipient based on the number of requested connections from the other senders.

10. A method according to claim 9, wherein the recipient sets a time period for which the maximum number of connections can be established based on the number of requested connections from the other senders.

11. A method according to claim 9, wherein the recipient sets a starting time for establishing each connection of the maximum number of connections that can be established based on the number of requested connections from the other senders.

12. A method according to claim 8, further comprising maintaining a job queue, wherein the job queue is maintained by a schedule manager and governs the number of current connections existing between all of the plural senders, as compared to an incoming number of requested connections.

13. A method according to claim 12, further comprising assigning a priority to each of the plural senders, wherein priority is assigned by the schedule manager to assign a larger number of connections to a higher priority sender as compared to a lower number of connections to a lower priority sender.

14. A method according to claim 12, wherein the sender sends a request to the recipient to open one or more connections when an I/O storage system of the sender is reading data faster than data is being sent out over the network, and wherein when autotuning the number of connections, the recipient opens the requested one or more connections if the one or more connections are determined available by the schedule manager.

15. A method according to claim 1, wherein the sender sends a request to the recipient to open one or more connections when a round-trip time (RTT) has decreased from a previous RTT, and wherein when autotuning the number of connections, the recipient opens the requested one or more connections if one or more connections are determined available by a schedule manager.

16. A method according to claim 12, wherein when autotuning the number of connections, the connections are opened and closed for a period of time set by the schedule manager.

17. A method according to claim 16, wherein the period of time set by the schedule manager is a different period of time for each of the different connections.

18. A method according to claim 16, wherein each of the connections are opened at a different starting time.

19. A method for mass transfer of data from a sender to a recipient connected to the sender via a network, the method comprising:
establishing plural connections between the sender and the recipient via the network;
sending data from the sender to the recipient by divided sending of the data over the plural connections so as to aggregate a utilization of a bandwidth of the network; and
autotuning the number of connections between the sender and the recipient by opening a new connection when an I/O storage system of the sender is reading data faster than data is being sent out over the network, and by closing an existing connection when the I/O storage system of the sender is reading data slower than data is being sent out over the network and more than one sender is sending data to the recipient.

20. A method according to claim 19, wherein autotuning further comprises closing an existing connection between the sender and the recipient in a case that the sender detects that a bottleneck to mass transfer of data exists in the network, so as to reduce further congestion in the network.

21. A method according to claim 20, wherein an affirmative detection is made of a bottleneck to mass transfer of data in the network when a current round-trip time (RTT) is longer than a previous RTT.

22. A method according to claim 19, wherein autotuning further comprises closing an existing connection between the sender and the recipient in a case that the sender detects that a bottleneck to mass transfer of data exists in the I/O storage system of the sender, and wherein an affirmative detection is made of a bottleneck to mass transfer of data in the I/O storage system of the sender when a buffer at the sender is substantially empty.

23. A method according to claim 19, wherein autotuning further comprises sending a request to the recipient to open a new connection when it is determined that a round-trip time (RTT) has decreased from a previous RTT.

24. A recipient comprising:
a computer-readable memory constructed to store computer-executable process steps; and
a processor constructed to execute the computer-executable process steps stored in the memory,
wherein the process steps in the memory cause the processor to perform a mass transfer of data from a sender to a recipient connected to the sender via a network, and wherein the process steps stored in the memory include computer-executable steps to:
establish plural connections between the sender and the recipient via the network;
send data from the sender to the recipient by divided sending of the data over the plural connections so as to aggregate a utilization of a bandwidth of the network; and
autotune the optimal number of connections between the sender and the recipient by closing an existing connection when a detection is made that a bottleneck to mass transfer of data exists in an I/O storage system of the recipient, and by opening a new connection when the I/O storage system of the recipient is writing data faster than data is received from the network.

25. A recipient according to claim 24, wherein the I/O storage system includes a disk, and wherein when autotuning the number of connections, an affirmative detection is made of a bottleneck to mass transfer of data in the I/O storage system of the recipient when a seek operation of the disk is performed on the I/O storage system of the recipient.

26. A recipient according to claim 24, wherein the I/O storage system includes a disk, and wherein when autotuning the number of connections, an affirmative detection is made of a bottleneck to mass transfer of data in the I/O storage system of the recipient when the I/O storage system of the recipient is writing data to the disk slower than a previous I/O write rate.

27. A recipient according to claim 24, wherein autotuning further comprises closing by the sender of an existing connection between the sender and the recipient in a case that the sender detects that a bottleneck to mass transfer of data exists in the network, so as to reduce further congestion of the network.

28. A recipient according to claim 27, wherein an affirmative detection is made of a bottleneck to mass transfer of data in the network when a current round-trip time (RTT) is longer than a previous RTT.

29. A recipient according to claim 27, wherein the process steps stored in the memory further include computer-executable steps to:
adjust a buffer size at the sender and the recipient in accordance with a detection of a bottleneck in the network, or in accordance with a detection of a bottleneck in the I/O storage system of the recipient.

30. A recipient according to claim 24, wherein in a case that the sender detects that a buffer at the sender is substantially full, the sender sends a request to the recipient to open a new connection, or utilizes a connection that has already been created but is not currently being used to send data.

31. A recipient according to claim 24, wherein there are plural senders each sending a respective one of plural mass data transfers to the recipient.

32. A recipient according to claim 31, wherein when establishing plural connections between the sender and the recipient via the network, the recipient sets a maximum number of connections that can be established between the sender and the recipient based on the number of requested connections from the other senders.

33. A recipient according to claim 32, wherein the recipient sets a time period for which the maximum number of connections can be established based on the number of requested connections from the other senders.

34. A recipient according to claim 32, wherein the recipient sets a starting time for establishing each connection of the maximum number of connections that can be established based on the number of requested connections from the other senders.

35. A recipient according to claim 31, wherein the process steps stored in the memory further include computer-executable steps to:
maintain a job queue, wherein the job queue is maintained by a schedule manager and governs the number of current connections existing between all of the plural senders, as compared to an incoming number of requested connections.

36. A recipient according to claim 35, wherein the process steps stored in the memory further include computer-executable steps to:
assign a priority to each of the plural senders, wherein priority is assigned by the schedule manager to assign a larger number of connections to a higher priority sender as compared to a lower number of connections to a lower priority sender.

37. A recipient according to claim 35, wherein the sender sends a request to the recipient to open one or more connections when an I/O storage system of the sender is reading data faster than data is being sent out over the network, and wherein when autotuning the number of connections, the recipient opens the requested one or more connections if the one or more connections are determined available by the schedule manager.

38. A recipient according to claim 35, wherein the sender sends a request to the recipient to open one or more connections when a round-trip time (RTT) has decreased from a previous RTT, and wherein when autotuning the number of connections, the recipient opens the requested one or more connections if one or more connections are determined available by the schedule manager.

39. A recipient according to claim 35, wherein when autotuning the number of connections, the connections are opened and closed for a period of time set by the schedule manager.

40. A recipient according to claim 39, wherein the period of time set by the schedule manager is a different period of time for each of the different connections.

41. A recipient according to claim 39, wherein each of the connections are opened at a different starting time.

42. A sender comprising:
a computer-readable memory constructed to store computer-executable process steps; and
a processor constructed to execute the computer-executable process steps stored in the memory,
wherein the process steps in the memory cause the processor to perform a mass transfer of data from a sender to a recipient connected to the sender via a network, and wherein the process steps stored in the memory include computer-executable steps to:
establish plural connections between the sender and the recipient via the network;
send data from the sender to the recipient by divided sending of the data over the plural connections so as to aggregate a utilization of a bandwidth of the network; and
autotune the optimal number of connections between the sender and the recipient by opening a new connection when an I/O storage system of the sender is reading data faster than data is being sent out over the network, and by closing an existing connection when the I/O storage system of the sender is reading data slower than data is being sent out over the network and more than one sender is sending data to the recipient.

43. A sender according to claim 42, wherein autotuning further comprises closing an existing connection between the sender and the recipient in a case that the sender detects that a bottleneck to mass transfer of data exists in the network, so as to reduce further congestion in the network.

44. A sender according to claim 43, wherein an affirmative detection is made of a bottleneck to mass transfer of data in the network when a current round-trip time (RTT) is longer than a previous RTT.

45. A sender according to claim 42, wherein autotuning further comprises closing an existing connection between the sender and the recipient in a case that the sender detects that a bottleneck to mass transfer of data exists in the I/O storage system of the sender, and wherein an affirmative detection is made of a bottleneck to mass transfer of data in the I/O storage system of the sender when a buffer at the sender is substantially empty.

46. A sender according to claim 42, wherein autotuning further comprises sending a request to the recipient to open a new connection when it is determined that a round-trip time (RTT) has decreased from a previous RTT.

47. A computer-readable memory medium on which is stored computer-executable process steps for causing a processor to perform a mass transfer of data from a sender to a recipient connected to the sender via a network, the process steps comprising:
establishing plural connections between the sender and the recipient via the network;
sending data from the sender to the recipient by divided sending of the data over the plural connections so as to aggregate a utilization of a bandwidth of the network; and
autotuning the optimal number of connections between the sender and the recipient by closing an existing connection when a detection is made that a bottleneck to mass transfer of data exists in an I/O storage system of the recipient, and by opening a new connection when the I/O storage system of the recipient is writing data faster than data is received from the network.

48. A computer-readable memory medium on which is stored computer-executable process steps for causing a processor to perform a mass transfer of data from a sender to a recipient connected to the sender via a network, the process steps comprising:
establishing plural connections between the sender and the recipient via the network;
sending data from the sender to the recipient by divided sending of the data over the plural connections so as to aggregate a utilization of a bandwidth of the network; and
autotuning the optimal number of connections between the sender and the recipient by opening a new connection when an I/O storage system of the sender is reading data faster than data is being sent out over the network, and by closing an existing connection when the I/O storage system of the sender is reading data slower than data is being sent out over the network and more than one sender is sending data to the recipient.
